(19) United States
(12) Patent Application Publication
(10) Pub. No.: US 2005/0008328 A1
(43) Pub. Date: Jan. 13, 2005

(54) Information creating apparatus and method, reproducing apparatus, and method and program

(76) Inventors: Seiji Kawa, Kanagawa (JP); Takao Suzuki, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/868,839

(22) Filed: Jun. 17, 2004

(30) Foreign Application Priority Data
Jun. 18, 2003 (JP) P2003-172791

(51) Int. Cl. H04N 5/93; G11B 27/00

(52) U.S. Cl. 386/52; 386/55

(57) ABSTRACT

An information creating apparatus for creating information proposed to a reproducing apparatus to reproduce a predetermined data is disclosed, in which an information creating apparatus for creating reproduction control information proposed to a reproducing apparatus to reproduce a predetermined data, comprises: acquisition means of acquiring edit point information describing a start point and an end point that are set to said data; and creation means of creating said reproduction control information that controls reproduction of the data based on the edit point information, wherein; said reproduction control information includes either information representing the number of second pictures at the post-end point or information representing a decode end position required to display from the start point to the end point, where both of the information are decoded before a first picture at the end point is decoded.

### CROSS REFERENCE TO RELATED APPLICATION

This application claims priority from Japanese Priority Document No. 2003-172791, filed on Jun. 18, 2003 with the Japanese Patent Office, which document is hereby incorporated by reference.

### BACKGROUND OF THE INVENTION

1. Field of the Invention

The present invention relates to an information creating apparatus and method, a reproducing apparatus and method and a program, and more particularly, to an information creating apparatus and method, a reproducing apparatus and method and a program, which enable real-time reproduction of image data to be ensured without degrading an image quality etc.

2. Description of the Related Art

In recent years, recording medium such as CD-RW (Compact Disk ReWritable) and DVD-RW (Digital Versatile Disc ReWritable) adaptable to repeated writing and erasing of data are being widespread with a cost reduction thereof.

In these disk-shaped recording medium, random access to prescribed data is possible, and in the case of a repetition of writing and erasing of AV (Audio Visual) data such as video data and audio data, image data to be reproduced continuously is sometimes recorded separately in individually discrete areas.

Further, recording of continuous data in a separated state on a disk is also liable to be caused in the case of non-destructive editing of the image data.

The non-destructive editing is an editing method in which setting of so-called edit points such as IN point and OUT point to image data available as material data recorded on an optical disk etc. merely necessary, while editing (destruction) of the original material data itself is not required. In the non-destructive editing, a list called an Edit List etc., for instance, of edit points set at the time of editing is created. Then, reproduction of data resulting from the editing is performed by reproducing the recorded material data on the optical disc according to the edit points described in the Edit List.

According to the above non-destructive editing, when the material data undergoes irreversible conversion such as MPEG (Moving Picture Experts Group) encoding, for instance, it is not necessary to, after decoding the material data, connect decode results of the material data together according to the edit points described in the Edit List so as to perform again the MPEG encoding of the resultant connected material data. Thus, an image quality etc. may be prevented from degradation caused by a repetition of decoding and encoding.

By the way, when the non-destructive editing is applied to reproduce the image data recorded on the optical disk separately in the individually discrete areas, a reproducing apparatus available for reproduction of the above image data gives rise a seek operation at the time of transition of an reproducing object from a certain area to the other area.

Then, in case of a large length of seek time required for the seek, readout of image data to be reproduced on that occasion is not able to catch up the reproducing time, and the readout of image data is interrupted, in other words, real-time reproduction of the image data becomes impossible.

In this connection, a technology in which prescribed material data recorded in the separated state are rearranged as a Bridge Clip so that the seek time becomes shorter is described in Patent Document 1 listed below. This technology may secure the real-time reproduction of the image data by avoiding a buffer under-run caused due to the large length of the seek time.

Patent Document 1: Japanese Patent Laid-open No. 2002-158974.

The technology of creating the Bridge Clip to perform the reproduction with reference to the created Bridge Clip is effective in solving a seek-time problem that arises in the reproducing apparatus, in which case, however, when a decoder provided for the reproducing apparatus is limited to one decoder having a mono-fast decode speed, for instance, it is difficult to reproduce, according to the edit point described in the Edit List, image data (MPEG stream) recorded on the optical disk in the MPEG format.

Specifically, three types of pictures, I (Intra) picture, P (Predictive) picture and B (Bi-directionally predictive) picture, are available in the MPEG format. The I picture is intra-encoded without making reference to other pictures. The P picture is intra-encoded or, predictive-encoded by using a predicted image generated from the reference picture with reference to an I or P picture temporally displayed in advance. The B picture is intra-en coded or, predictive-encoded by using a predicted image generated from the reference picture with reference to one or both of the I or P picture temporally displayed in advance and an I or P picture temporally displayed subsequently.

A decode processing is also performed in this sequence and a picture temporally displayed subsequently is referred to, as required.

Accordingly, depending on a type (any of the I picture, the P picture and the B picture) of a picture at an IN point, it is necessary to decode a picture merely referred to for decoding other pictures, that is, a non-displayed picture, before a practically displayed picture is decoded, in which case the one decoder of the mono-fast speed sometimes fails to secure the real-time reproduction.

Specifically, a GOP-structured Long GOP (Group Of Picture) which is composed of 15 frame pictures and allows the I or P picture to be arranged at intervals of 3 pictures, for instance, is considered.

In this case, assuming that each picture contained in the GOP is expressed by a combination of an alphabetic character (I, P and B) representing the picture type thereof and a numeric character representing a display sequence, 1 GOP is composed of B1, B2, I3, B4, B5, P6, B7, B8, P9, B10, B11, P12, B13, B14 and P15.

The B picture is sometimes encoded with reference to not only the picture temporally displayed in advance but also the picture temporally displayed subsequently, so that it is not allowable to decode the B picture unless a picture displayed subsequently thereto is decoded over at the time when the B picture is decoded.

Thus, in the MPEG format, the picture referred to for decoding the B picture is decoded prior to the B picture. Accordingly, the pictures B1 to P15 contained in the above GOP are decoded in the sequence of I3, B1, B2, P6, B4, B5, P9, B7, B8, P12, B10, B11, P15, B13 and B14.

Specifically, the pictures B1 and B2 are decoded with reference to the picture P15 in the GOP displayed in advance and ahead by one, and the picture I3 of the same GOP displayed subsequently. The picture I3 is decoded without making reference to other pictures. The pictures B4 and B5 are decoded with reference to the picture I3 of the same GOP displayed in advance and the picture P6 of the same GOP displayed subsequently. The picture P6 is decoded with reference to the picture I3 of the same GOP displayed in advance. The pictures B7 and B8 are decoded with reference to the picture P6 of the same GOP displayed in advance and the picture P9 of the same GOP displayed subsequently. The picture P9 is decoded with reference to the picture P6 of the same GOP displayed in advance. The pictures B10 and B11 are decoded with reference to the picture P9 of the same GOP displayed in advance and the picture P12 of the same GOP displayed subsequently. The picture P12 is decoded with reference to the picture P9 of the same GOP displayed in advance. The pictures B13 and B14 are decoded with reference to the picture P12 of the same GOP displayed in advance and the picture P15 of the same GOP displayed subsequently. The picture P15 is decoded with reference to the picture P12 of the same GOP displayed in advance.

As described above, the number of pictures to be decoded before the picture at the edit point is decoded varies with the type of the picture at the edit point, leading to variations in decode start time and start position.

The decode processing of the image data recorded in the MPEG format is now described with reference to FIGS. 1A to 1C.

When the m-th GOP from the top of image data is expressed as GOP (m), and display of the pictures from B1 to B13 of the GOP (m) in a period between a time t₁ and time t₂ and display of the pictures from a picture P9 of GOP (n) to a picture P9 of GOP(n+1) followed by the GOP (n) in the subsequent period between the time t₂ and a time t₃ are requested according to the Edit List as shown in FIG. 1A, for instance, the decode processing in response to the request is performed as shown in FIG. 1B.

Specifically, the display of the pictures B1 to B13 of the GOP(m) available in the period between the time₁ and the time₂ in the sequence listed requires that the pictures be decoded in the sequence of I3, B1, B2, P6, B4, B5, P9, B7, B8, P12, B10, B11, P15 and B13.

Further, the display of the pictures P9 to B15 of the GOP (n) available in the period between the time₂ and the time₃ in the sequence listed requires that the pictures be decoded in the sequence of I3, P6, P9, P12, B10, B11, P15, B13 and B14. At this time, the reference to the picture P6 is required to decode the picture P9 at the IN point of the GOP(n), and the reference to the picture I3 is required to decode the picture P6. Thus, the pictures as to the GOP(n) are decoded in the sequence of I3, P6, P9, . . . inclusively of the non-displayed pictures I3 and P6.

Likewise, the display of the pictures B1 to P9 of the GOP(n+1) in the sequence listed requires that the pictures be decoded in the sequence of I3, B1, B2, P6, B4, B5, P9, B7 and B8.

In FIG. 1B, it is necessary that decode of the picture B1 of the GOP (m) be over before the time t₁ at which a start to display the picture B1 is required. Accordingly, a time to be started the decode of the picture I3 of the GOP (m) is set at a time t₁′ earlier than the time t₁ by a period required to decode two pictures (the pictures I3 and B1)

Likewise, it is also necessary that the decode of the picture P9 of the GOP (n) be over before the time t₂ (a display end time of the picture B13 of the GOP (m)) at which a start to display the picture P9 is required. Thus, it becomes necessary that the decode of the picture P9 be started before a time t₂′ earlier than the time t₂ by a period essentially required to decode the picture P9 itself.

However, as shown in FIG. 1B, the decode of the picture P9 is practically started at a time t₂″ later than the time t₂ by a period required to decode one picture (the picture P6), providing the decode start position that is behind by a portion corresponding to the period between the time t₂′ and the time t₂″. In other words, a freeze occurs in a displayed video image by the period required to decode the pictures I3 and I6 which are not displayed but referred to in decoding the picture P9.

As shown in FIG. 1C, a period between the time t₂ (a time essentially to be started the display of the picture B9 of the GOP (n)) at which the display of the picture B13 of the GOP (m) is over and a display start time t₄ of the picture P9 of the GOP (n) corresponds to the period (the period required to decode two pictures) between the time t₂′ and the time t₂″ in FIG. 1B, and the displayed image suffers the freeze in the above period.

Specifically, it is necessary to decode also the non-displayed picture, in addition to the displayed pictures, depending on a position of an edit point. Thus, while the invention described in the Patent document 1 is considered to be effective in solving the seek-time problem, the solution of the seek-time problem is not enough to ensure the real-time production of the image data.

Incidentally, in FIGS. 1A and 1B, when the GOP(m) and the GOP(n) are arranged in the individually discrete areas, a seek time required to switch the object of reproduction also occurs, which practically leads to a freeze period longer than the period required to decode the two pictures.

Further, the invention described in the Patent document 1 prescribes, as restrictions on edited image data, that reproduction of connection points (edit points) in a seamless state requires that image data obtained by removing unnecessary pictures around the connection points be re-encoded to unite the individual image data into one continuous stream that meets MPEG standards (as described in a later paragraph, for instance). Thus, a problem also arises in which the re-encoded data leads to the degradation of the image quality.

When the edit point is contained in the Bridge Clip including a plurality of GOPs, for instance, it is necessary to create the Bridge Clip by once decoding the data and then by re-encoding data obtained by the removal of the unnecessary pictures therefrom, resulting in the problem in which the re-encoded data leads to the quality degradation of a video image obtained by the reproduction of the Bridge Clip.

The present invention has been carried out in view of the above circumstances, and is intended to enable the real-time reproduction of image data to be ensured without degrading the image quality etc.

### SUMMARY OF THE INVENTION

An information creating apparatus according to the present invention comprises: acquisition means of acquiring edit point information describing a start point and an end point that are set to the data; and creation means of creating the reproduction control information that controls reproduction of the data based on the edit point information, wherein; the reproduction control information includes either information representing the number of second pictures at the post-end point or information representing a decode end position required to display from the start point to the end point, where both of the information are decoded before a first picture at the end point is decoded.

The creation means may be arranged to perform creation of the reproduction control information which further includes either information representing the number of fourth pictures at the post-start point or information representing a decode start position required to start displaying with the start point, where both of the information are decoded before a third picture at the start point is decoded.

The creation means may be also arranged to perform creation of reproduction control information which further includes information specifying a decoder of a reproducing apparatus to be used to decode the data.

The creation means may be further arranged to perform creation of reproduction control information that specifies a data position by address information adaptable to be processed with the reproducing apparatus.

An information creating method according to the present invention comprises: an acquisition step of acquiring edit point information describing a start point and an end point that are set at data; and a creation step of creating reproduction control information that controls reproduction of the data based on the edit point information, wherein; the reproduction control information includes either information representing the number of second pictures at the post-end point or information representing a decode end position required to display from the start point to the end point, where both of the information are decoded before a first picture at the end point is decoded.

A first program of the present invention comprises: an acquisition step of acquiring edit point information describing a start point and an end point that are set at data; and a creation step of creating reproduction control information that controls reproduction of the data based on the edit point information, wherein; the reproduction control information includes either information representing the number of second pictures at the post-end point or information representing a decode end position required to display from the start point to the end point, where both of the information are decoded before a first picture at the end point is decoded.

A reproducing apparatus according to the present invention comprises: acquisition means of acquiring a reproduction control information created based on edit point information describing a start point and an end point that are set at prescribed data; and reproduction means of reproducing the data based on the reproduction control means acquired with the acquisition means, wherein; the reproduction control information includes either information representing the number of second pictures at the post-end point or information representing a decode end position required to display from the start point to the end point, where both of the information are decoded before a first picture at the end point is decoded.

A reproducing method according to the present invention comprises an acquisition step of acquiring reproduction control information created based on edit point information describing a start point and an end point that are set at prescribed data; and a reproduction step of reproducing the data based on the reproduction control information acquired through a processing in the acquisition step, wherein; the reproduction control information includes either information representing the number of second pictures at the post-end point or information representing a decode end position required to display from the start point to the end point, where both of the information are decoded before a first picture at the end point is decoded.

A second program according to the present invention comprises: an acquisition step of acquiring reproduction control information created based on edit point information describing a start point and an end point that are set at prescribed data; and a reproduction step of reproducing the data based on the reproduction control information acquired through a processing in the acquisition step, wherein; the reproduction control information includes either information representing the number of second pictures at the post-end point or information representing a decode end position required to display from the start point to the end point, where both of the information are decoded before a first picture at the end point is decoded.

In the information creating apparatus and method and the first program according to the present invention, the edit point information describing the start point and the end point that are set at the data is acquired to create the reproduction control information that controls the reproduction of the data wherein the data at least includes either the information representing the number of post-end point second pictures to be decoded before the first picture at the endpoint is decoded or the information representing the decode end position required to display from the start point to the end point.

In the reproducing apparatus and method and the second program according to the present invention, the reproduction control information created based on the edit point information describing the start point and the end point that are set at the prescribed data is acquired to reproduce the data based on the acquired reproduction control information. Further, the reproduction control information includes at least either the information representing the number of post-end point second pictures to be decoded before the first picture at the end point is decoded or the information representing the decode end position required to display from the start point to the end point.

The present invention enables the real-time reproduction of the image data to be performed. Further, the present invention also enables the reproduction of the image data to start more quickly.

### BRIEF DESCRIPTION OF THE DRAWINGS

FIGS. 1A to 1C are views illustrating an embodiment of reproduction of image data;

FIG. 2 is a block diagram showing an embodiment of a configuration of a disk apparatus obtained with the present invention applied;

FIGS. 3A and 3B are views illustrating an embodiment of creation of a Bridge Essence;

FIG. 4 is a view illustrating an embodiment of creation of an Edit List;

FIG. 5 is a block diagram showing an embodiment of the configuration of the disk apparatus;

FIG. 6 is a block diagram showing an embodiment of a configuration of a reproducing apparatus obtained with the present invention applied;

FIG. 7 is a block diagram showing an embodiment of the configuration of the reproducing apparatus;

FIG. 8 is a view illustrating decode scheduling;

FIGS. 9A, 9B, and 9C are views illustrating an embodiment of decoding with a plurality of decoders;

FIG. 10 is a view illustrating Nip of each picture;

FIG. 11 is a view illustrating requirements of scheduling;

FIG. 12 is a flowchart illustrating a Play List creation processing performed with the disk apparatus of FIG. 2;

FIG. 13 is a flowchart following the flowchart of FIG. 12 to illustrate the Play List creation processing performed with the disk apparatus of FIG. 2;

FIG. 14 is a view illustrating an embodiment of the Edit List;

FIG. 15 is a view illustrating an embodiment of a picture pointer;

FIG. 16 is a view illustrating an embodiment of creation of a Bridge Essence;

FIG. 17 is a view illustrating an embodiment of the Bridge Essence;

FIG. 18 is a view illustrating an embodiment of a Play List;

FIG. 19 is a view showing a different embodiment of the Play List;

FIG. 20 is a flowchart illustrating a reproduction processing performed with the reproducing apparatus of FIG. 6;

FIG. 21 is a view illustrating the reproduction of the image data;

FIG. 22 is a view illustrating an embodiment of display of the image data;

FIG. 23 is a block diagram showing a different embodiment of the configuration of the disk apparatus obtained with the present invention applied;

FIG. 24 is a block diagram showing a different embodiment of the configuration of the reproducing apparatus obtained with the present invention applied;

FIG. 25 is a flowchart illustrating a processing performed with the disk apparatus of FIG. 23;

FIG. 26 is a view illustrating an embodiment of a Play List created through the processing of FIG. 25;

FIG. 27 is a flowchart illustrating a reproduction processing performed with the reproducing apparatus of FIG. 24;

FIG. 28 is a block diagram showing a further different embodiment of the configuration of the disk apparatus obtained with the present invention applied;

FIG. 29 is a block diagram showing a further different embodiment of the configuration of the reproducing apparatus obtained with the present invention applied;

FIG. 30 is a flowchart illustrating a processing performed with the disk apparatus of FIG. 28;

FIG. 31 is a view illustrating a correspondence between pictures at an OUT point and postDecDur Attribute;

FIG. 32 is a view illustrating an embodiment of a Play List created through the processing of FIG. 30;

FIG. 33 is a flowchart illustrating a processing performed with the reproducing apparatus of FIG. 29;

FIG. 34 is a flowchart illustrating a different processing performed with the disk apparatus of FIG. 28;

FIG. 35 is a view illustrating an embodiment of a Play List created through the processing of FIG. 34;

FIG. 36 is a flowchart illustrating a different processing performed with the reproducing apparatus of FIG. 29;

FIG. 37 is a view illustrating an embodiment of a different Play List; and

FIG. 38 is a block diagram showing an embodiment of a configuration of an information processing device.

### DETAILED DESCRIPTION OF THE PREFERRED EMBODIMENTS

Embodiments of the present invention are next described, and an illustration of a correspondence between constituents as defined in claims and specific embodiments in the embodiments of the present invention is given as follows. The following description is to confirm that the specific embodiments for supporting the present invention described in claims are given in the description of the embodiments of the present invention. Thus, even if there are any specific embodiments that are not illustrative herein as those meeting the constituents, although being given in the description of the embodiment of the present invention, this does not mean that these specific embodiments are not those meeting the constituents. Conversely, even if the specific embodiments are illustrative herein as those meeting the constituents, this does not mean too that these specific embodiments are not those meeting the constituents other than the above constituents.

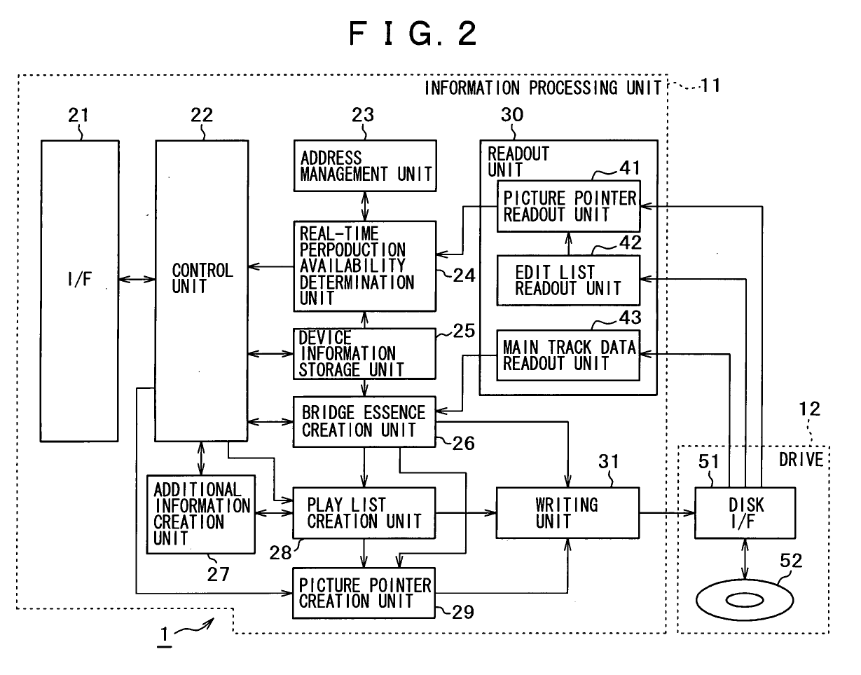

FIG. 2 is a block diagram showing an embodiment of a configuration of a disk apparatus i (an information creating apparatus) obtained with the present invention applied.

In FIG. 2, the disk apparatus 1 is composed of an information processing unit 11 and a drive 12.

The information processing unit 11 is composed of an I/F (Interface) 21, a control unit 22, an address management unit 23, a real-time reproduction availability determination unit 24, a device information storage unit 25, a Bridge Essence creation unit 26, an additional information creation unit 27, a Play List creation unit 28, a picture pointer creation unit 29, a readout unit 30 and a writing unit 31, and reads out an Edit List stored in an optical disk 52 placed in the drive 12 to create a Play List based on the Edit List.

The Edit List used herein is referred to as a list of so-called edit points (IN points (start points) and OUT points (end points)) respectively set at prescribed positions of AV (Audio Visual) data (particularly, video data in the present invention) recorded on the optical disk 52. The Play List is referred to as a list obtained by rewriting of the Edit List so as to ensure real-time reproduction of image data (image data recorded on the optical disk 52 together with the Play List) resulting from non-destructive editing using the IN points and the OUT points described in the Edit List in the case of reproduction of the above image data with a reproducing apparatus.

Specifically, MPEG (Moving Picture Experts Group)-encoded image data and the created Edit List in editing of the image data are recorded on the optical disk 52. However, in the case of the reproduction of the image data simply according to the recorded Edit List with the reproducing apparatus mounted with the optical disk 52, the above problem on the seek time or on the freeze caused depending on the edit point position sometimes leads to a failure in the real-time reproduction of the image data.

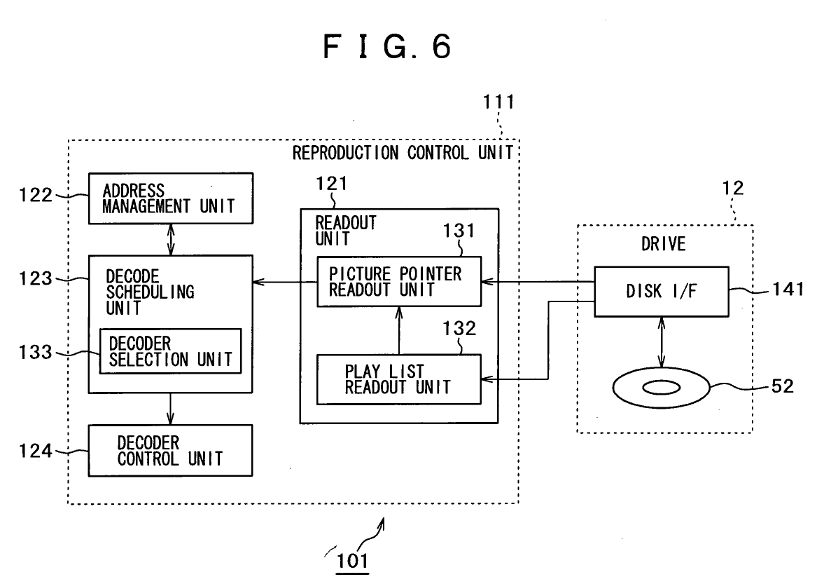

Thus, the information processing unit 11 writes, onto the optical disk 52, the Play List newly created by rewriting the Edit List to ensure the real-time reproduction of the image data recorded on the optical disk 52. Subsequently, in the reproducing apparatus (a reproducing apparatus 101 (FIG. 6) described later, for instance) mounted with the optical disk 52 containing the Play List, the reproduction of the image data recorded on the optical disk 52 together with the Play List, in other words, the image data reproduction whose real-time efficiency is ensured takes place according to the Play List.

A description on the creation of the Play List and the image data reproduction performed based on the Play List is given later in detail with reference to flowcharts.

In FIG. 2, the I/F 21 performs control on an operation unit such as a keyboard and a mouse, a display to display an image and a speaker to output voice (sounds) (any of these units is not shown). Then, when the operation part is operated through the user, the I/F 21 supplies, to the control unit 22, a signal corresponding to the given operation. The I/F 21 also outputs suitably, through the display and the speaker, information supplied from the control unit 22.

The control unit 22 controls, in response to an operation signal supplied from the I/F 21, for instance, the real-time reproduction availability determination unit 24, the device information storage unit 25, the Bridge Essence creation unit 26, the additional information creation unit 27, the Play List creation unit 28 and the picture pointer creation unit 29.

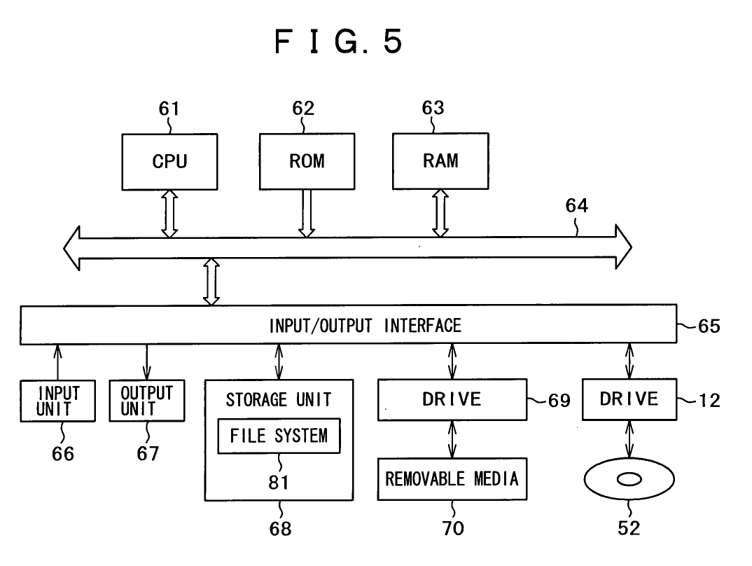

The address management unit 23 is implemented with a file system 81 (FIG. 5) to manage a physical address and a logical address of the optical disk 52. Upon reception of the logical address of the image data from the real-time reproduction availability determination unit 24, for instance, the address management unit 23 converts the above logical address into the physical address to output the physical address to the real-time reproduction availability determination unit 24. In the real-time reproduction availability determination unit 24, it is determined, based on the physical address supplied from the address management unit 23, whether or not the real-time reproduction of the image data recorded on the optical disk 52 is possible.

The real-time reproduction availability determination unit 24 determines, based on the Edit List and a picture pointer supplied from the picture pointer readout unit 41 or information supplied from the device information storage unit 25, whether or not the reproducing apparatus is capable of reproducing, in real time, the image data resulting from the non-destructive editing.

As described later, the picture pointer is table information added to a Clip thereof, for instance, and the table describes information relating to each picture, such as a data size of each picture contained in the Clip, a file address (a logical address) and a picture type representing that the given picture is of which type, among I (Intra) picture, P (Predictive) picture and B (Bidirectionally predictive) picture.

The device information storage unit 25 stores device information specified as information relating to specifications of the reproducing apparatus to suitably provide these information for the real-time reproduction availability determination unit 24 and the Bridge Essence creation unit 26. The device information stored with the device information storage unit 25 includes a readout rate of a disk drive incorporated in the reproducing apparatus, a buffer capacity, an image data reproduction rate (a decode speed) and the number of decoders, for instance. The device information may be arranged to be capable of being set by the operation of the operation unit through the user, or to contain information relating to the standardized specifications of the reproducing apparatus in advance.

The Bridge Essence creation unit 26 creates a Bridge Clip (which is suitably also referred to as a Bridge Essence) based on data supplied from a main track data readout unit 43 so as to attain a reduction in seek time at the time of reproduction of the image data, when it is determined by the real-time reproduction availability determination unit 24 that the reproducing apparatus fails to perform the real-time reproduction of a prescribed range of image data (which is suitably also referred to as a Clip (a series of video data formed in GOP (Group Of Picture, for instance) units)).

It is necessary that the Bridge Essence (the Bridge Clip) be created when the transition of an object of reproduction from a certain area to the other area in the case of the reproduction of the image data recorded on the optical disk separately in the individually discrete areas requires the large length of seek time which leads to the buffer underflow, as described above.

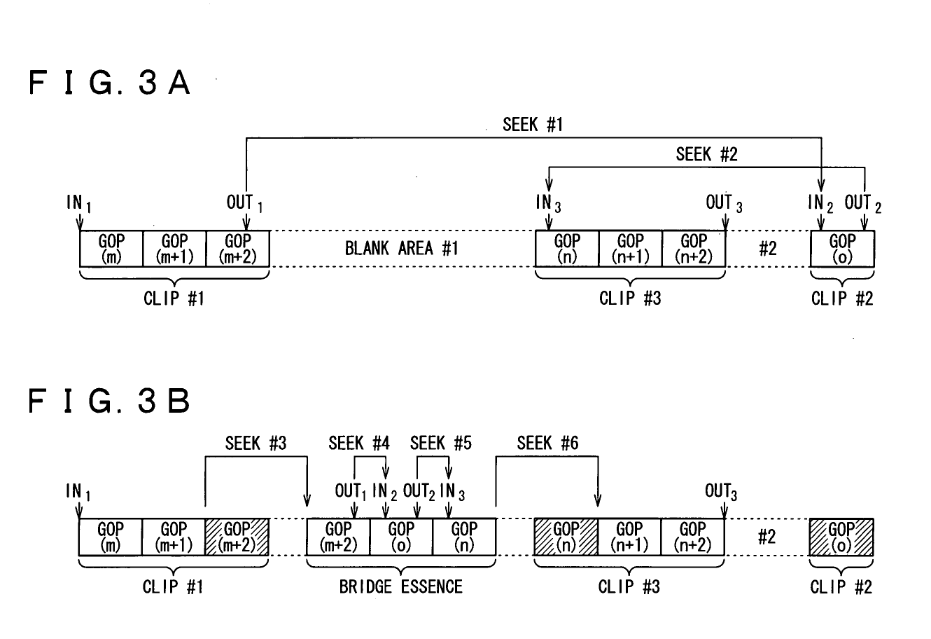

The creation of the Bridge Essence with the Bridge Essence creation unit 26 is now described with reference to FIGS. 3A and 3B. In FIGS. 3A and 3B, a direction of reading of data from the optical disk 52 and writing of the data thereto is assumed to be from the left to the right.

Provided that the m-th GOP from the head of image data is expressed as GOP(m), there are now shown, in FIG. 3A, a Clip #1 composed of GOP(m), GOP(m+1) and GOP (m+2), a Clip #2 composed of GOP(0) and a Clip #3 composed of GOP(n), GOP(n+1) and GOP (n+2). In addition, the GOP (m+2) and the GOP (n) have therebetween a blank area #1, and the GOP (n+2) and the GOP(0) have also therebetween a blank area #2. The repetition of recording and erasing of data sometimes causes the optical disk 52 to have the blank areas as described above.

In the above condition, it is assumed that the image data is being edited such that the reproduction of the image data from the first picture (a picture at an IN₁ point) of the GOP (m) to a picture at an OUT₁ point of the GOP (m+2) takes place, and the reproduction thereof from a picture at an IN₂ point of the GOP(0) arranged posterior to the GOP(m+2) to a picture at an OUT₂ point posterior thereto follows, and is further followed by the reproduction thereof from a picture at an IN₃ point of the GOP(n) arranged anterior to the GOP(0) to the last picture (a picture at an OUT₃ point) of the GOP (n+2)

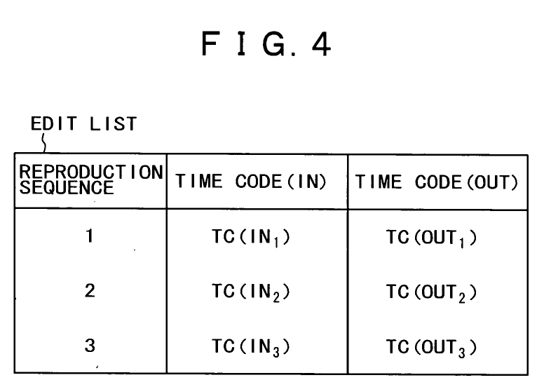

In other words, the above reproductions are performed according to the Edit List as shown in FIG. 4.

In FIG. 4, TC(IN₁) represents a time code TC (Time Code) of the IN₁ point set at the Clip #1, and TC(OUT₁) represents a time code of the OUT₁ point set at the Clip #1. Likewise, TC(IN₂) and TC(OUT₂) represent a time code of the IN₂ point and a time code of the OUT₂ point respectively set at the Clip #2, and TC (IN₃) and TC (OUT₃) represent a time code of the IN₃ point and a time code of the OUT₃ point respectively set at the Clip #3.

With reference to the Edit List shown in FIG. 4, the pictures in the range of the picture specified by TC(IN₁) to the picture specified by TC (OUT₁) are reproduced firstly, and the pictures in the range of the picture specified by TC (IN₂) to the picture specified by TC(OUT₂) are reproduced secondly. Further, the pictures in the range of the picture specified by TC (IN₃) to the picture specified by TC (OUT₃) are reproduced thirdly. In other words, the reproduction of the image data shown in FIG. 3A is performed.

A processing of creating the Edit List to perform the reproduction according to the created Edit List at the time of reproduction enables desired editing to be performed (a desired editing result to be obtained) without re-encoding the image data.

Further, the non-destructive editing using the Edit List is effective in preventing the degradation of the image quality, as compared with the case of the image data editing performed by decoding once the image data resulting from encoding with the irreversible conversion such as the MPEG format, and by, after the purge of the unnecessary pictures (the pictures that are not included in the range from the IN point to the OUT point) that are specified as non-object of reproduction, encoding again the remaining image data obtained by the purge of the unnecessary pictures.

Referring to the description in FIG. 3A again, the Clips #1 and #2 and the Clips #2 and #3 are respectively recorded in the discrete areas, so that in the case of the reproduction according to the Edit List of FIG. 4, the seek #1 and the seek #2 arise respectively at the time of transition of a read-out object from the OUT₁ point of the Clip #1 to the IN₂ point of the Clip #2 and transition of the read-out object from the OUT₂ point of the Clip #2 to the IN₃ point of the Clip #3.

Accordingly, in the case of the large length of the seek time as described above, the readout of the image data from the optical disk 52 is performed at a time later than the time to reproduce the image data in real time, resulting in breaking of the reproduction.

The reproducing apparatus has, for instance, a buffer for storing (buffering) temporarily the image data read out from the optical disk 52 and a decoder for reading out the buffered image data to decode the read-out data. However, when thorough readout of the buffered image data with the decoder leads to the buffer underflow for the duration of seek, the breaking of the real-time reproduction occurs. In other words, an assurance of the real-time reproduction requires that even in the presence of the seek, the image data for making sure of decoding for a period corresponding to the period required for the seek be stored in the buffer.

Thus, the Bridge Essence creation unit 26 of FIG. 2 rearranges a part of the Clips in GOP units into the blank area, for instance, to attain the reduction in seek time, and also specifies the Bridge Essence composed of the plurality of rearranged GOPs as data of the object of reproduction to ensure the real-time efficiency of the reproduction in the reproducing apparatus.

Specifically, when it is determined by the real-time reproduction availability determination unit 24 that in the case of the reproduction of the image data of FIG. 3A with the reproducing apparatus according to the Edit List, the buffer underflow may occur while the seek #1 or #2 is arising, the Bridge Essence creation unit 26 creates the Bridge Essence by rearranging the data in a prescribed range of the Clips requiring the seek, that is, data in GOP units into the blank area #1.

In an embodiment of FIG. 3B, the GOP(m+2) of the Clip #1, the GOP(0) of the Clip #2 and the GOP(n) of the Clip #3 are rearranged into the blank area #1, so that the Bridge Essence composed of the GOP (m+2), the GOP(0) and the GOP (n) is created.

After the creation of the Bridge Essence as described above, the disk apparatus 1 provides, for the reproducing apparatus together with the image data, the Play List created by rewriting the Edit List to perform the reproduction with reference to the Bridge Essence.

Upon reception of the Play List and the image data, the reproducing apparatus switches the object of reproduction to the Bridge Essence after the reproduction of the pictures in the range of the first picture of the GOP (m) to the last picture of the GOP (M+1) according to the Play List, as shown in FIG. 3B. Specifically, the reproducing apparatus performs the reproduction of the pictures in the range of the first picture to the picture at the OUT₁ point of the GOP(m+2) contained in the Bridge Essence, then, the reproduction of the pictures in the range of the picture at the IN₂ point to the picture at the OUT₂ point of the GOP(0), and further, the reproduction of the pictures in the range of the picture at the IN₃ point of the GOP (n) to the last picture of the GOP (n). After the reproduction of the Bridge Essence, the reproducing apparatus performs the reproduction of the pictures in the range of the first picture of the GOP(n+1) to the last picture of the GOP(n+2) of the Clip #3.

In FIG. 3B, non-reproduced GOPs are shown with slant lines.

When the Bridge Essence is specified as the object of reproduction, a seek #3 arises at the time of transition of an object of readout from the last picture of the GOP(m+1) to the first picture of the GOP(m+2) of the Bridge Essence, and a seek #4 also arises at the time of transition of the object of readout from the picture at the OUT₁ point of the GOP (m+2) to the picture at the IN₂ point of the GOP(0). Further, a seek #5 arises at the time of transition of the object of readout from the picture at the OUT₂ point of the GOP(0) to the picture at the IN₃ point of the GOP (n), and a seek #6 also arises at the time of transition of the object of readout from the last picture of the GOP(n) to the first picture of the GOP(n+1).

As is apparent from a comparison between FIGS. 3A and 3B, a total period required for the seek #3 to the seek #6 (FIG. 3B) is shorter than a total period required for the seek #1 and the seek #2, although the same video image is displayed. Thus, the reference to the Bridge Essence is effective in reducing the seek time, resulting in prevention of the buffer underflow.

Referring to the description with reference to FIG. 2 again, the Bridge Essence creation unit 26 outputs the created Bridge Essence as described above to the writing unit 31 to write the Bridge Essence onto the disk 52 through the disk I/F 51. The Bridge Essence creation unit 26 also outputs, to the Play List creation unit 28 and the picture pointer creation unit 29 etc., information such as the time code and the address on the arrangement of the Bridge Essence, as Bridge Essence-related information.

The additional information creation unit 27 creates additional information used for the creation of the Play List to output the additional information to the Play List creation unit 28. The additional information includes, for instance, information that specifies a decode start position of each Clip, information that specifies a decode end position and information that specifies the decoder, that is, which decoder is used to reproduce which Clip in the case of the reproducing apparatus having a plurality of decoders.

The Play List creation unit 28 creates the Play List based on the Edit List supplied from the control unit 22, the Bridge Essence-related information supplied from the Bridge Essence creation unit 26 and the additional information supplied from the additional information creation unit 27. The Play List is described in a prescribed language such as XML (eXtensible Markup Language) base language, for instance. The created Play List is outputted from the Play List creation unit 28 to the picture pointer creation unit 29 and the writing unit 31.

The picture pointer creation unit 29 creates, based on the picture pointer supplied from the control unit 22, a picture pointer of the Clip (assumed to be the object of reproduction) referred to by the Play List to output the picture pointer to the writing unit 31. The picture pointers relating to all the Clips recorded on the optical disk 52 are read out from the optical disk 52 through the picture pointer readout unit 41, and are then supplied to the picture pointer creation unit 29 through the real-time reproduction availability determination unit 24.

The readout unit 30 is composed of the picture pointer readout unit 41, the Edit List readout unit 42 and the main track data readout unit 43. The Edit List readout unit 42 reads out the Edit List recorded on the optical disk 52 to output the Edit List to the picture pointer readout unit 41.

The picture pointer readout unit 41 reads out, from the optical disk 52 based on the Edit List supplied from the Edit List readout unit 42, the picture pointer of the Clip referred to by the given Edit List. The image data and the picture pointer of each Clip contained in the image data are recorded on the optical disk 52. The read-out picture pointer is outputted from the picture pointer readout unit 41 to the real-time reproduction availability determination unit 24 together with the Edit List.

The main track data readout unit 43 reads out, through the disk I/F 51, main track data (the image data) recorded on the optical disk 52 to output the main track data to the Bridge Essence creation unit 26.

The writing unit 31 writes, onto the blank area of the optical disk 52 through the drive I/F 51, the Bridge Essence supplied from the Bridge Essence creation unit 26. The writing unit 31 also writes, on the optical disk 52 through the disk I/F 51, the Play List created with the Play List creation unit 28 and the picture pointer (the picture pointer of the Clip referred to by the Play List) created with the picture pointer creation unit 29.

The drive 12 has the disk I/F 51, and performs writing of data onto the optical disk 52 placed in the drive 12 and reading of the data therefrom. Specifically, the disk drive 12 is arranged such that the optical disk 52 may be easily placed in the drive 12 or removed therefrom.

The information such as the image data obtained through image-capturing with a video camera, the picture pointer of each Clip contained in the image data and the Edit List are, for instance, recorded on the optical disk 52. Available disks for the optical disk 52 include, for instance, a Blu-ray (trademark) disk, a CD (Compact Disk) and a DVD (Digital Versatile Disk) etc.

Each of the above units is implemented with a personal computer shown in FIG. 5, for instance.

A CPU (Central Processing Unit) 61 performs various kinds of processing according to a program stored in a ROM (Read Only Memory) 62 or a program loaded from a storage unit 68 to a RAM (Random Access Memory) 63. The file system 81 is, for instance, stored in the storage unit 68, and the address management unit 23 of FIG. 2 is implemented by running of the file system.

Data etc. required for the CPU 61 to perform various kinds of processing is stored suitably also in the RAM 63.

The CPU 61, the ROM 62 and the RAM 63 are interconnected through a bus 64. An input/output interface 65 is also connected to the bus 64.

An input unit 66 composed of a keyboard and a mouse etc., and an output unit 67 composed of a display such as a CRT (Cathode Ray Tube) and a LCD (Liquid Crystal Display) and a speaker etc. are connected to the input/output interface 65. A command inputted by an operation of the input unit 66 through the user is supplied to the I/F 21 of FIG. 2. Incidentally, a menu of Edit Lists stored in the optical disk 52 is, for instance, displayed on the display contained in the output unit 67. The Play List is created with the information processing unit 11 based on the Edit List selected from the Edit List menu.

The storage unit composed of a hard disk etc., the drive 69 and the drive 12 (FIG. 2) are also connected to the input/output interface 65. A recording medium other than the optical disk 52, that is, a removal media 70 such as a memory card integrated with a flash memory, a magnetic disk and a magnetic tape, for instance, is mounted in the drive 69, so that reading of data from the removal media 70 and writing of data thereto are performed with the drive 69.

FIG. 6 is a block diagram showing an embodiment of a configuration of the reproducing apparatus 101.

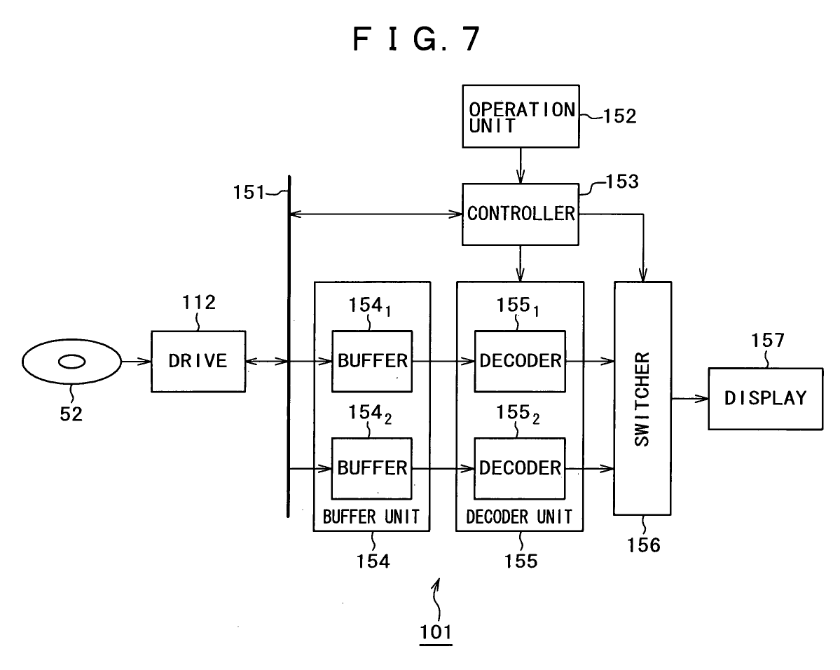

A reproduction control unit 111 is composed of a readout unit 121, an address management unit 122, a decode scheduling unit 123 and a decoder control unit 124. These units are implemented by running of a prescribed control program with a controller 153 of FIG. 7.

The reproduction control unit 111 reproduces the image data recorded on the optical disk 52 placed in a drive 112, according to the Play List recorded on the optical disk 52 together with the image data. In addition to the image data, each Clip picture pointer and the Play List etc. created with the disk apparatus 1 are also recorded on the optical disk 52.

The readout unit 121 is composed of a picture pointer readout unit 131 and a Play List readout unit 132. The Play List readout unit 132 reads out the Play List recorded on the optical disk 52 to output the Play List to the picture pointer readout unit 131.

The picture pointer readout unit 113 reads out, from the optical disk 52, the picture pointer of the Clip referred to by the Play List supplied from the Play List readout unit 132. The read-out picture pointer is outputted from the picture pointer readout unit 131 to the decode scheduling unit 123 together with the Play List.

The address management unit 122 manages the physical address and the logical address of the optical disk 52. Specifically, a program module similar to the file system 81 of FIG. 5 is provided also for the controller 153 of FIG. 7, and the address management part 122 is implemented by running of the program module. For instance, the address management unit 122 converts the logical address supplied from the decode scheduling unit 123 into the physical address to provide the physical address for the decode scheduling unit 123.

Upon reception of the physical address of the image data from the address management unit 122, the decode scheduling unit 123 performs decode scheduling based on the Play List and the picture pointer supplied from the picture pointer readout unit 131 to determine a decode start position (the picture) of each Clip.

The decode scheduling unit 123 also determines which decoder starts decoding, based on the determined decode start position by using a decoder selection unit 133. As shown in FIG. 7, the reproducing apparatus 101 has a plurality of decoders (two decoders in an embodiment shown in FIG. 7). Both of schedule information representing the decode start position etc. and decoder specifying information representing the specific decoder are outputted to the decoder control unit 124.

The decoder control unit 124 controls the decoders based on the schedule information and the decoder specifying information.

The drive 112 has a disk I/F 141, and performs writing of data onto the optical disk 52 placed in the drive 112 and reading of the data therefrom.

Each unit of the above reproduction control unit 111 is implemented with the reproducing apparatus 101 of FIG. 7, for instance.

An operation unit 152 is operated through the user to output an operation signal corresponding to the given operation to the controller 153.

The controller 153 controls the disk drive 112, a decoder unit 155 and a switcher 156 in response to the operation signal etc. from the operation unit 152. Specifically, upon reception of the operation signal relating to a request for the reproduction of the image data according to the Play List from the operation unit 152, the controller 153 issues a Play List request to the disk drive 112. Further, the controller 153 receives the Play List that is outputted to the bus 151 after being read out from the optical disk 52 with the disk drive 112 in response to the request.

The controller 153 (the decode scheduling unit 123 of FIG. 6) also performs the decode scheduling and decoder selection based on the received Play List to control, based on the schedule information and the decoder specifying information, the image data decode processing performed with decoders 155₁ and 155₂. The controller 153 also controls the switcher 156 based on the edit point detected from the Play List to allow the switcher 156 to select and output any of the pictures decoded with the decoder 155₁ or 155₂.

A buffer unit 154 is composed of buffers 154₁ and 154₂, and buffers the image data read out with the drive 112. The image data having been buffered with the buffer 154₁ is decoded with the decoder 155₁ arranged in a posterior stage of this buffer. The image data having been buffered with the buffer 154₂ is decoded with the decoder 155₂ arranged at a posterior stage of this buffer. Incidentally, there is provided the Play List described so as to be referred to the Bridge Essence suitably as described above, so that the reproduction performed according to the Play List causes no buffer underflow in the buffers 154₁ and 154₂.

The decoders 155₁ and 155₂ contained in the decoder unit 155 respectively issue image data requests to the drive 112 through a bus 151 to receive, through the buffers 154₁ and 154₂, the image data outputted from the drive 112 to the bus 151 in response to the above requests. The decoders 155₁ and 155₂ also decode the received image data according to control from the controller 153 to output the decoded image (the pictures) to the switcher 156.

The decoders 155₁ and 155₂ contained in the decoder 155 are herein assumed to have a mono-fast decode processing speed, for instance. The drive 112 reads out the image data from the optical disk 52 to supply the image data to the buffer 154₁ (the decoder 155₁) and the buffer 154₂ (the decoder 155₂), in which case the drive is also assumed to have a readout speed (transmission bandwidth) sufficient for supply of the image data.

The switcher 156 selects, based on the control with the controller 153, any of the pictures having been decoded with the decoder 155₁ or 155₂ to output the selected picture to a display 157. The display 157 displays the picture outputted with the switcher 156. Thus, the picture displayed on the display 157 is the picture selected with the switcher 156 among the pictures having been decoded with the decoder 155₁ or 155₂.

The decode scheduling performed with the decode scheduling unit 123 is now described.

The assurance of the real-time reproduction in decoding the image data encoded in the Long GOP sometimes requires that the picture merely referred to for decoding other pictures, in other words, the non-displayed picture be decoded before the practically displayed pictures are decoded, depending on the type of the picture at the IN point (any of I picture, P picture and B picture), as described above.

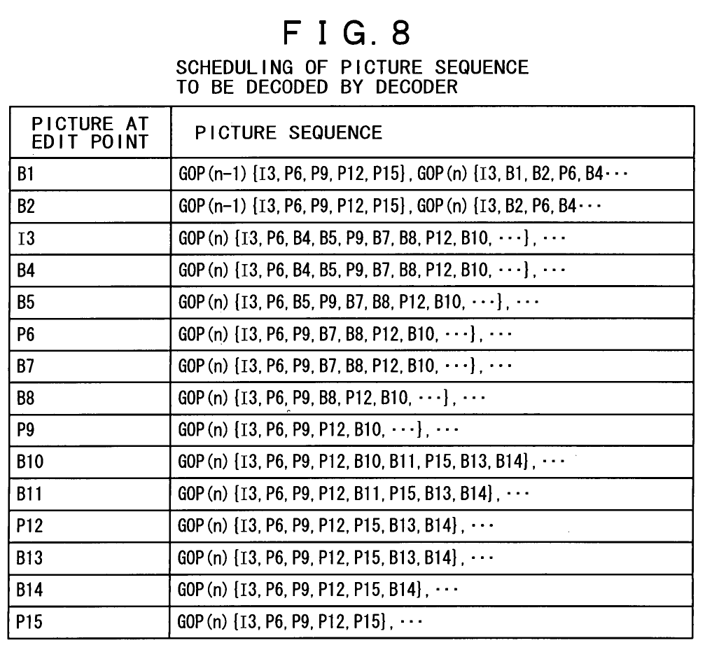

Thus, the decode scheduling unit 123 performs the decode scheduling as shown in FIG. 8. Specifically, the decode scheduling unit 123 detects the picture at the edit point (IN point) from the Play List and the picture pointer supplied from the picture pointer readout unit 131 to determine, in response to the picture at the edit point, a picture sequence to be decoded with the decoder 155₁ or 155₂. In FIG. 8, the n-th GOP from the head of the image data is also expressed as the GOP(n).

Specifically, as shown in FIG. 8, when the picture at the edit point is the picture B1 of the GOP (n), the irreducible minimal non-displayed pictures to be decoded for decoding the picture B1 of the GOP (n) are assumed to be five pictures, i.e., the pictures I3, P6, P9, P12 and P15 of the GOP (n−1), in which case the decode scheduling unit 123 schedules so as to start decoding with the pictures I3, P6, P9, P12 and P15 of the GOP(n−1). Further, all that required thereafter is to decode the pictures on and after the GOP(n) in sequence, so that the decode scheduling unit 123 schedules so as to decode the pictures on and after the GOP(n) in an ordinary decode sequence (13, B1, B2, P6, B4, . . . ), following the pictures I3, P6, P9, P12 and P15 of the GOP(n−1).

When the picture at the edit point is the picture B2 of the GOP (n), the irreducible minimal non-displayed pictures to be decoded for decoding the picture B2 of the GOP(n) are assumed to be five pictures, i.e., the pictures I3, P6, P9, P12 and P15 of the GOP (n−1), in which case the decode scheduling unit 123 schedules so as to start decoding with the pictures I3, P6, P9, P12 and P15 of the GOP (n−1). Further, while the pictures I3, B1, B2, P6, . . . of the GOP(n) are thereafter decoded, the picture B1 prior in display sequence to the picture B2 at the edit point is neither displayed nor referred to, so that it is not necessary to decode the picture B1. Thus, the decode scheduling unit 23 schedules so as to decode the picture B2 followed by the picture B6 after decoding the picture I3 of the GOP(n), following the pictures I3, P6, P9, P12 and P15 of the GOP(n−1), and also schedules so as to decode the following pictures in the ordinary decode sequence.

When the picture at the edit point is the I3 of the GOP (n), the reference to other pictures is not required to decode the picture I3, in which case while decoding is started with the picture I3 of the GOP (n), the pictures B1 and B2 prior in display sequence to the picture I3 at the edit point is neither displayed nor referred to, so that it is not necessary to decode the pictures B1 and B2. Thus, the decode scheduling part 123 schedules so as to decode the picture P6 without decoding the pictures Bland B2, after decoding the picture I3 of the GOP (n) and also schedules so as to decode the following pictures in the ordinary decode sequence.

When the picture at the edit point is the picture B4 of the GOP (n), the irreducible minimal non-displayed pictures to be decoded for decoding the picture B4 of the GOP(n) are assumed to be the picture I3 of the GOP (n), in which case the decode scheduling unit 123 schedules so as to start decoding with the picture I3 of the GOP (n). Further, while the pictures B1, B2, P6, B4, B5, . . . posterior in decode sequence (encode sequence) to the picture I3 of the GOP(n) are thereafter decoded, the pictures B1 and B2 prior in display sequence to the picture B4 at the edit point are neither displayed nor referred to, so that it is not necessary to decode the pictures B1 and B2. Thus, the decode scheduling unit 123 schedules so as to decode the picture P6 without decoding the pictures B1 and B2, after decoding the picture I3 of the GOP(n) and also schedules so as to decode the following pictures in the ordinary decode sequence.

When the picture at the edit point is the picture B5 of the GOP(n), the irreducible minimal non-displayed pictures to be decoded for decoding the picture B5 of the GOP(n) are assumed to be the picture I3 of the GOP (n), in which case the decode scheduling unit 123 schedules so as to start decoding with the picture I3 of the GOP (n). Further, while the pictures B1, B2, P6, B4, B5, . . . posterior in decode sequence to the picture I3 of the GOP (n) are thereafter decoded, the pictures B1, B2 and B4 prior in display sequence to the picture B5 at the edit point are neither displayed nor referred to, so that it is not necessary to decode the pictures B1 and B2 and B4. Thus, the decode scheduling unit 123 schedules so as to decode the picture P6 without decoding the pictures B1, B2, after decoding the picture I3 of the GOP(n). Further, the decode scheduling unit 123 schedules so as to decode the picture B5 without decoding the picture B4, following the picture P6, and also schedules so as to decode the following pictures in the ordinary decode sequence.

When the picture at the edit point is the picture P6 of the GOP(n), the irreducible minimal non-displayed pictures to be decoded for decoding the picture P6 of the GOP(n) are assumed to be the picture I3 of the GOP(n), in which case the decode scheduling unit 123 schedules so as to start decoding with the picture I3 of the GOP (n). Further, while the pictures B1, B2, P6, B4, B5 . . . posterior in decode sequence to the picture I3 of the GOP (n) are thereafter decoded, the pictures B1, B2, B4 and B5 prior in display sequence to the picture P6 at the edit point are neither displayed nor referred to, so that it is not necessary to decode the pictures B1, B2, B4 and B5. Thus, the decode scheduling unit 123 schedules so as to decode the picture P6 without decoding the pictures B1 and B2, after decoding the picture I3 of the GOP(n) Further, the decode scheduling unit 123 schedules so as to decode the picture P9 without decoding the pictures B4 and B5, following the picture P6, and also schedules so as to decode the following pictures in the ordinary decode sequence.

When the picture at the edit point is the picture B7 of the GOP (n), the irreducible minimal non-displayed pictures to be decoded for decoding the picture B7 of the GOP(n) are assumed to be the pictures I3 and P6 of the GOP(n), in which case the decode scheduling unit 123 schedules so as to start decoding with the pictures I3 and P6 of the GOP (n). Further, while the pictures B4, B5, P9, B7 and B8 posterior in decode sequence to the picture P6 of the GOP(n) are thereafter decoded, the pictures B4 and B5 prior in display sequence to the picture B7 at the edit point are neither displayed nor referred to, so that it is not necessary to decode the pictures B4 and B5. Thus, the decode scheduling unit 123 schedules so as to decode the picture P9 without decoding the pictures B4 and B5, after decoding the picture P6 of the GOP(n) and also schedules so as to decode the following pictures in the ordinary decode sequence.

When the picture at the edit point is the picture B8 of the GOP (n), the irreducible minimal non-displayed pictures to be decoded for decoding the picture B8 of the GOP(n) are assumed to be the pictures I3 and P6 of the GOP(n), in which case the decode scheduling unit 123 schedules so as to start decoding with the pictures I3 and P6 of the GOP (n). Further, while the pictures B4, B5, P9, B7, B8 . . . posterior in decode sequence to the picture P6 of the GOP (n) are thereafter decoded, the pictures B4, B5 and B7 prior in display sequence to the picture B8 at the edit point are neither displayed nor referred to, so that it is not necessary to decode the picture B4, B5 and B7. Thus, the decode scheduling unit 123 schedules so as to decode the picture P9 without decoding the pictures B4 and B5, after decoding the picture P6 of the GOP (n). Further, the decode scheduling unit 123 schedules so as to decode the picture B8 without decoding the picture B7, following the picture P9, and also schedules so as to decode the following pictures in the ordinary decode sequence.

When the picture at the edit point is the picture P9 of the GOP(n), the irreducible minimal non-displayed pictures to be decoded for decoding the picture P9 of the GOP (n) are assumed to be the pictures I3 and P6 of the GOP (n), in which case the decode scheduling unit 123 schedules so as to start decoding with the pictures I3 and P6 of the GOP (n). Further, while the pictures B4, B5, P9, B7, B8, P12, B10, B11 . . . posterior in decode sequence to the picture P6 of the GOP(n) are thereafter decoded, the pictures B4, B5, B7 and B8 prior in display sequence to the picture P9 at the edit point are neither displayed nor referred to, so that it is not necessary to decode the pictures B4, B5, B7 and B8. Thus, the decode scheduling unit 123 schedules so as to decode the picture P9 without decoding the pictures B4 and B5, after decoding the picture P6 of the GOP(n). Further, the decode scheduling unit 123 schedules so as to decode the picture P12 without decoding the pictures B7 and B8, following the picture P9, and also schedules so as to decode the following pictures in the ordinary decode sequence.

When the picture at the edit point is the picture B10 of the GOP(n), the irreducible minimal non-displayed pictures to be decoded for decoding the picture B10 of the GOP(n) are assumed to be the pictures I3, P6 and P9 of the GOP(n), in which case the decode scheduling unit 123 schedules so as to start decoding with the pictures I3, P6 and P9 of the GOP(n). Further, while the pictures B7, B8, P12, B10, B11, . . . posterior in decode sequence to the picture P9 of the GOP(n) are thereafter decoded, the pictures B7 and B8 prior in display sequence to the picture B10 at the edit point are neither displayed nor referred to, so that it is not necessary to decode the pictures B7 and B8. Thus, the decode scheduling unit 123 schedules so as to decode the picture P12 without decoding the pictures B7 and B8, after decoding the picture P9 of the GOP(n), and also schedules so as to decode the following pictures in the ordinary decode sequence.

When the picture at the edit point is the picture B11 of the GOP(n), the irreducible minimal non-displayed pictures to be decoded for decoding the picture B1 of the GOP(n) are assumed to be the pictures I3, P6 and P9 of the GOP(n), in which case the decode scheduling unit 123 schedules so as to start decoding with the pictures I3, P6 and P9 of the GOP(n) Further, while the pictures B7, B8, P12, B10, B11, posterior in decode sequence to the picture P9 of the GOP(n) are thereafter decoded, the pictures B7, BB and B10 prior in display sequence to the picture B11 at the edit point are neither displayed nor referred to, so that it is not necessary to decode the pictures B7, B8 and B10. Thus, the decode scheduling unit 123 schedules so as to decode the picture P12 without decoding the pictures B7 and B8, after decoding the picture P9 of the GOP(n). Further, the decode scheduling unit 123 schedules so as to decode the picture B11 without decoding the picture B10, following the picture P12, and also schedules so as to decode the following pictures in the ordinary decode sequence.

When the picture at the edit point is the picture P12 of the GOP(n), the irreducible minimal non-displayed pictures to be decoded for decoding the picture P12 of the GOP(n) are assumed to be the pictures I3, P6 and P9 of the GOP(n), in which case the decode scheduling unit 123 schedules so as to start decoding with the pictures I3, P6 and P9 of the GOP(n) Further, while the pictures B7, BB, P12, B10, B11, P15, B13 and B14 posterior in decode sequence to the picture P9 of the GOP(n) and the pictures of the next GOP are thereafter decoded, the pictures B7, B8, B10 and B11 prior in display sequence to the picture P12 at the edit point are neither displayed nor referred to, so that it is not necessary to decode the pictures B7, B8, B10 and B11. Thus, the decode scheduling unit 123 schedules so as to decode the picture P12 without decoding the pictures B7 and BB, after decoding the picture P9 of the GOP(n). Further, the decode scheduling unit 123 schedules so as to decode the picture P15 without decoding the pictures B10 and B11, following the picture P12, and also schedules so as to decode the following pictures in the ordinary decode sequence.

When the picture at the edit point is the picture B13 of the GOP(n), the irreducible minimal non-displayed pictures to be decoded for decoding the picture B13 of the GOP(n) are assumed to be the pictures I3, P6, P9 and P12 of the GOP(n), in which case the decode scheduling unit 123 schedules so as to start decoding with the pictures I3, P6, P9 and P12 of the GOP(n). Further, while the pictures B10, B11, P15, B13 and B14 posterior in decode sequence to the picture P12 of the GOP(n) and the pictures of the next GOP are thereafter decoded, the pictures B10 and B11 prior in display sequence to the picture P12 at the edit point are neither displayed nor referred to, so that it is not necessary to decode the pictures B10 and B11. Thus, the decode scheduling unit 123 schedules so as to decode the picture P15 without decoding the pictures B10 and B11, after decoding the picture P12 of the GOP(n), and also schedules so as to decode the following pictures in the ordinary decode sequence.

When the picture at the edit point is the picture B14 of the GOP(n), the irreducible minimal non-displayed pictures to be decoded for decoding the picture B14 of the GOP(n) are assumed to be the pictures I3, P6, P9 and P12 of the GOP(n), in which case the decode scheduling unit 123 schedules so as to start decoding with the pictures I3, P6, P9 and P12 of the GOP(n). Further, while the pictures B10, B11, P15, B13 and B14 posterior in decode sequence to the picture P12 of the GOP(n) and the pictures of the next GOP are thereafter decoded, the pictures B10, B1 and B13 prior in display sequence to the picture B14 at the edit point are neither displayed nor referred to, so that it is not necessary to decode the pictures B10, B11 and B13. Thus, the decode scheduling unit 123 schedules so as to decode the picture P15 without decoding the pictures B10 and B11, after decoding the picture P12 of the GOP(n). Further, the decode scheduling unit 123 schedules so as to decode the picture B14 without decoding the picture B13, following the picture P15, and also schedules so as to decode the following pictures in the ordinary decode sequence.

When the picture at the edit point is the picture P15 of the GOP(n), the irreducible minimal non-displayed pictures to be decoded for decoding the picture P15 of the GOP(n) are assumed to be the pictures I3, P6, P9 and P12 of the GOP(n), in which case the decode scheduling unit 123 schedules so as to start decoding with the pictures I3, P6, P9 and P12 of the GOP(n). Further, while the pictures B10, B11, P15, B13 and B14 posterior in decode sequence to the picture P12 of the GOP(n) and the pictures of the next GOP are thereafter decoded, the pictures B10, B11, B13 and B14 prior in display sequence to the picture P15 at the edit point are neither displayed nor referred to, so that it is not necessary to decode the pictures B10, B1, B13 and B14. Thus, the decode scheduling unit 123 schedules so as to decode the picture P15 without decoding the pictures B10 and B1, after decoding the picture P12 of the GOP(n). Further, the decode scheduling unit 123 schedules so as to decode (the picture I3 of) the next GOP without decoding the pictures B13 and B14, following the picture P15, and also schedules so as to decode the following pictures in the ordinary decode sequence.

The number of pictures to be decoded for the reference in decoding pictures other than the picture at the edit point (IN point) before the picture at the edit point is decoded varies with the picture at the edit point. Thus, the decode start position is determined depending on the above number of pictures.

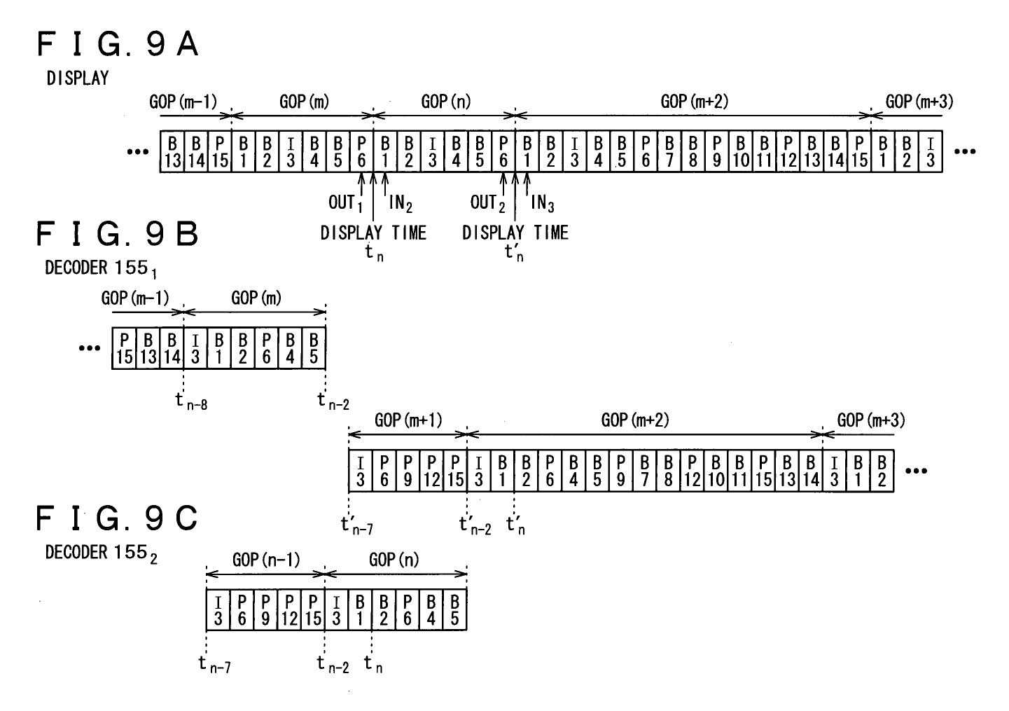

As shown in FIG. 9A, when display of the image data in the range of the picture of a certain GOPᵢ to the picture P6 at the OUT₁ point of the GOP(m) takes place, and display thereof in the range of the picture B1 at the IN₂ point of the GOP(n) to the picture P6 at the OUT₂ point of the GOP(n) follows and is further followed by display thereof in the range of the picture B1 at the IN₃ point of the GOP(m+2) to the following pictures, for instance, the decode start position and the decode start time of each of the decoders 155₁ and 155₂ are determined as follows.

In this case, the decode scheduling unit 123 allows one of the two decoders 155₁ and 155₂, that is, the decoder 155₁, for instance, to decode the pictures I3, B1, B2, P6, B4 and B5 displayed in the GOP(m), as shown in FIG. 9B.

Incidentally, for decoding the pictures I3, B1, B2, P6, B4 and B5 of the GOP(m), it is necessary that the finally decoded picture B5 among the pictures of the GOP(m) be decoded over before a time tₙ₋₂ to be displayed the picture B5. Thus, with this consideration, the time to be started decoding the GOP(m) is set at a time tₙ₋₈ earlier than the time tₙ₋₂ by a display period corresponding to the display of six pictures, i.e., the pictures B1 to P6 of the GOP(m).

In FIGS. 9A to 9C, a time tₙ represents a time (a time to be ended the display of the picture P6 of the GOP(m)) to be started displaying the first picture B1 of the GOP(n). Also, a time tₙ₋ᵢ represents a time earlier than the time tₙ by a period required to display one frame.

After the pictures B1 to P6 of the GOP(n) are decoded with the decoder 155₁, and displayed, the OUT₁ point is reached as shown in FIG. 9A, so that it is necessary to subsequently decode and display the pictures B1 to P6 of the GOP(n) headed by the IN₂ point and ended by the OUT₂ point.

The picture at the IN₂ point is now the picture B1 of the GOP(n), in which case the decode scheduling unit 123 allows the other decoder 155₂ out of the two decoders 155₁ and 155₂ to decode the pictures I3, P6, P9, P12 and P15 of the GOP(n−1) prior to the GOP(n) by one GOP, and to subsequently decode the pictures I3, B1, B2, P6, B4 and B5 of the GOP(n), as described above with reference to FIG. 8. Thus, the decode start position is set at the picture I3 of the GOP(n−1).

Incidentally, for decoding the pictures I3, B1, B2, P6, B4 and B5 of the GOP(n), it is necessary that the picture B1 at the IN₂ point be decoded over before the time tₙ to be displayed the picture B1. Thus, the decode scheduling unit 123 determines the decode start time of the decoder 155₂ so as to start decoding the picture I3 of the GOP(n−1) prior to the picture B1 of the GOP(n) by seven pictures before a time tₙ₋₇ earlier than the time tₙ by the display period corresponding to the display of seven pictures.

By the way, the decoder 155, ends the decode processing after the pictures I3, B1, B2, P6, B4 and B5 of the GOP(m) are decoded over. However, after the picture B5 of the GOP(n) is decoded with the decoder 155₂ to permit the pre-decoded picture P6 to be displayed, the OUT₂ point is reached, as shown in FIG. 9A, so that it is necessary to subsequently decode and display the pictures on and after the GOP(m+2) headed by the IN₃ point.

The picture at the IN₃ point is the picture B1 of the GOP(m+2), in which case the decode scheduling unit 123 allows the decoder 155, to decode the pictures I3, P6, P9, P12 and P15 of the GOP(m+1) prior to the GOP(m+2) by one GOP, and to subsequently decode the pictures I3, B1, B2, P6, B4, B5, . . . of the GOP(m+2), as described above with reference to FIG. 8. Thus, the decode start position is set at the picture I3 of the GOP(m+1).

For decoding the GOP(m+2), it is necessary that the picture B1 at the IN₃ point be decoded over before a time t′ₙ to be displayed the picture B1. Thus, the decode scheduling unit 123 determines the decode start time of the decoder 155, so as to start decoding the picture I3 of the GOP(m+1) prior to the picture B1 of the GOP(m+2) by seven pictures before a time t′ₙ₋₇ earlier than the time t′ₙ by the display period corresponding to the display of seven pictures.

Herein, in FIGS. 9A to 9C, the time t′ₙ represents a time (a time to be ended the display of the picture P6 of the GOP(n)) to be started displaying the first picture B1 of the GOP(m+2). Also, a time t′ₙ₋ᵢ represents a time earlier than the time t′ₙ by a period required to display one frame.

As described above, the decode scheduling unit 123 calculates the number of pictures to be decoded before the picture at the edit point is displayed, and determines, as the decode start position, the head picture to be pre-decoded, among the above calculated pictures. The decode scheduling unit 123 also determines the decode start time by retroaction from the display time of the picture at the edit point by the period required to decode the calculated number of pictures.

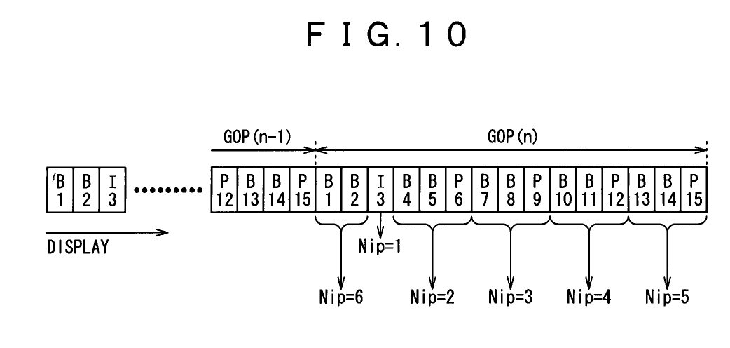

FIG. 10 is a summarized illustration on the number of pictures to be decoded to display the picture at the edit point before the display time of the picture at the edit point.

As shown in FIG. 10, the number of pictures to be decoded before the display of the picture at the edit point is equivalent to the number of I and P pictures in the range of the picture at the edit point to the temporally retroactive first I picture. In FIG. 10, when the picture at the edit point is of the I or P picture type, the number of the I and P pictures in the range of the picture at the edit point to the temporally retroactive first I picture, inclusive of the I or P picture itself, is expressed as Nip.

When the picture at the edit point is the picture B1 or B2 of the GOP(n), for instance, the pictures to be decoded before the picture B1 or B2 is decoded are assumed to be six pictures, i.e., the pictures I3, P6, P9, P12 and P15 of the GOP(n−1) and the picture I3 of the GOP(n), in which case the Nip is [6].

When the picture at the edit point is the picture I3 of the GOP(n), the reference to other pictures is not required to decode the picture I3, in which case the Nip is equal to the number of picture I3 itself, i.e., [1].

When the picture at the edit point is the picture B4 or B5 of the GOP(n), the pictures to be decoded before the picture B4 or B5 is decoded are assumed to be two pictures, i.e., the pictures I3 and P6 of the GOP(n), in which case the Nip is [2].

When the picture at the edit point is the picture P6 of the GOP(n), the pictures to be decoded before the picture P6 is decoded are assumed to be the picture I3 of the GOP(n), in which case the Nip is [2] obtained as the sum of the one picture P6 itself and the one picture I3.

When the picture at the edit point is the picture B7 or B8 of the GOP(n), the pictures to be decoded before the picture B7 or B8 is decoded are assumed to be three pictures, i.e., the pictures I3, P6 and P9 of the GOP(n), in which case the Nip is [3].

When the picture at the edit point is the picture P9 of the GOP(n), the pictures to be decoded before the picture P9 is decoded are assumed to be two pictures, i.e., the pictures I3 and P6 of the GOP(n), in which case the Nip is [3] obtained as the sum of the one the picture P9 itself and the two pictures I3 and P6.

When the picture at the edit point is the picture B10 or B11 of the GOP(n), the pictures to be decoded before the picture B10 or B11 is decoded are assumed to be four pictures, i.e., the pictures I3, P6, P9 and P12 of the GOP(n), in which case the Nip is [4].

When the picture at the edit point is the picture P12 of the GOP(n), the pictures to be decoded before the picture P12 is decoded are assumed to be three pictures, i.e., the pictures I3, P6 and P9 of the GOP(n), in which case the Nip is [4] obtained as the sum of the one picture P12 itself and the three pictures I3, P6 and P9.

When the picture at the edit point is the picture B13 or B14 of the GOP(n), the pictures to be decoded before the picture B13 or B14 is decoded are assumed to be five pictures, i.e., the pictures I3, P6, P9, P12 and P15 of the GOP(n), in which case the Nip is [5].

When the picture at the edit point is the picture P15 of the GOP(n), the pictures to be decoded before the picture P15 is decoded are assumed to be four pictures, i.e., the pictures I3, P6, P9 and P12 of the GOP(n), in which case the Nip is [5] obtained as the sum of the one picture P15 itself and the four pictures I3, I6, P9 and P12.

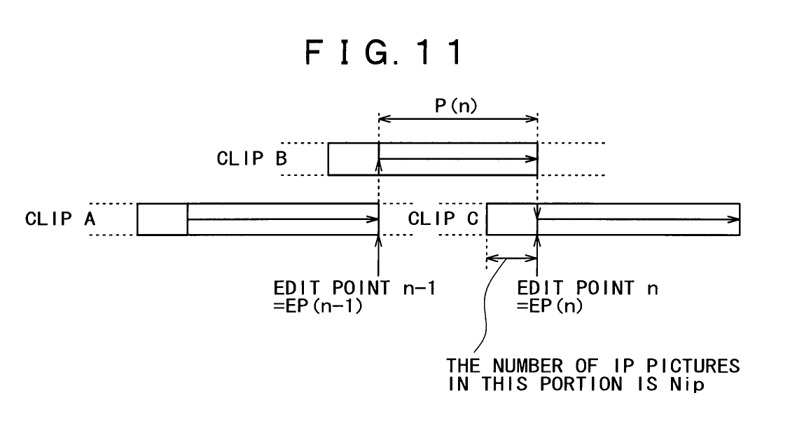

FIG. 11 illustrates requirements in the decode scheduling.

It is now assumed that the position of an edit point n and the position of an edit point n−1 prior to the edit point n by one are respectively expressed as EP(n) and EP(n−1), and a Clip having the OUT point at EP(n−1), a Clip having the OUT point at EP(n) and a Clip having the IN point at EP(n) are respectively expressed as Clip A, Clip B and Clip C. It is also assumed that the number of displayed pictures of the Clip B is expressed as P (n), and the number of pictures to be decoded before the display of the picture at the IN point of the Clip C is expressed as the Nip as described above.

In this case, the decode scheduling with the reproducing apparatus 101 having two decoders as shown in FIG. 7 is performed to meet the following requirements, depending on whether or not the Clip A and the Clip C are the same.

(1) If the Clip A and the Clip C are not the same, P(n) and Nip have to satisfy P(n)>=Nip.

Specifically, in the case where the Clip A and the Clip C are not the same, it is necessary that while one decoder is decoding the pictures as-many as those expressed in terms of the P(n), the other decoder should decode, concurrently with the above decode processing, the pictures as many as those expressed in terms of the Nip before the display of the picture at the IN point of the Clip C, so that the decode scheduling is performed so as to meet this requirement.

(2) If the Clip A and the Clip C are the same, (a) a time difference between the IN point of the Clip C and the OUT point of the Clip A has to shorter than a period required to display the P(n).

Specifically, when the time difference between the IN point of the Clip C and the OUT point of the Clip A is shorter than the period required to display the P(n), the Clip A and the Clip Care considered to be the same, enabling the scheduling to be attained such that the pictures, inclusive of the pictures between the OUT point of the Clip A and the IN point of the Clip C, are decoded over at the display time of the picture at the IN point of the Clip C, by continuously decoding the above pictures without the seek from the OUT point of the Clip A to the IN point of the Clip C.

(b) If the above requirement (a) is not satisfied, the requirement (1) has to be satisfied. Conversely, when the time difference between the IN point of the Clip C and the OUT point of the Clip A is longer than the period required to display the P(n), it is necessary to decode the pictures as many as those expressed in terms of the Nip before the display of the picture at the IN point of the Clip C, as described above.

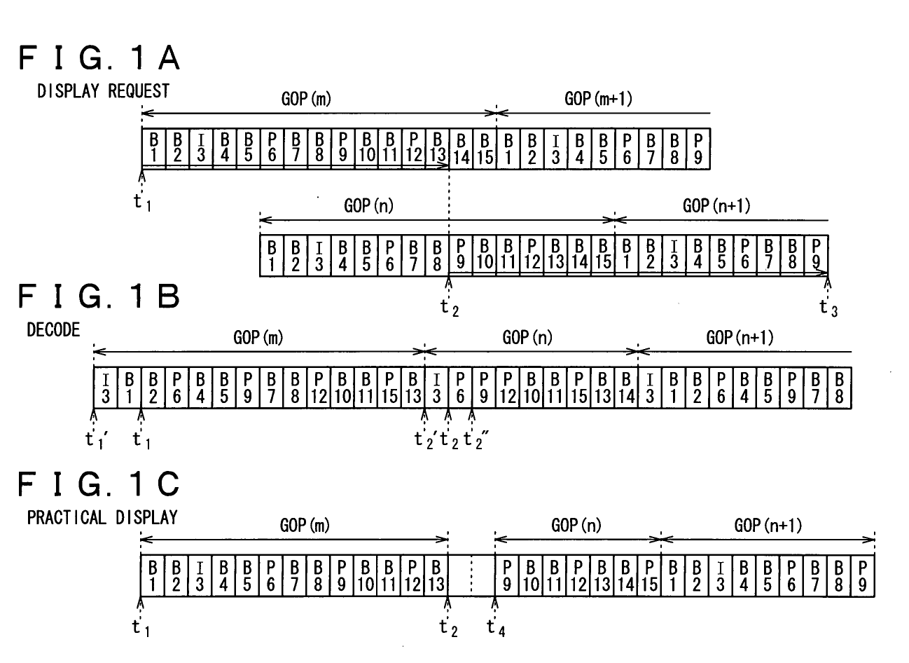

In the reproducing apparatus 101, the decode scheduling is performed as described above to permit the image data to be decoded according to the schedule information representing the scheduling result. This may avoid the freeze (the state in FIG. 1C) from appearing in the displayed video image, and thus permits the real-time reproduction.

Incidentally, while there has been described the case of the reproducing apparatus 101 having the two decoders of the mono-fast decode speed, the P(n) in the case of a reproducing apparatus having three or more decoders is expressed as follows,
P(n)=EP(n)−EP(n−DN+1)
wherein [DN] represents the number of decoders and [DS] represents the decode speed, respectively. Further, the above requirement (1) is changed as follows.
   P(n)>=Nip/DS.

An operation of the disk apparatus 1 and the reproducing apparatus 101 respectively having the above configurations is now described with reference to flowcharts.

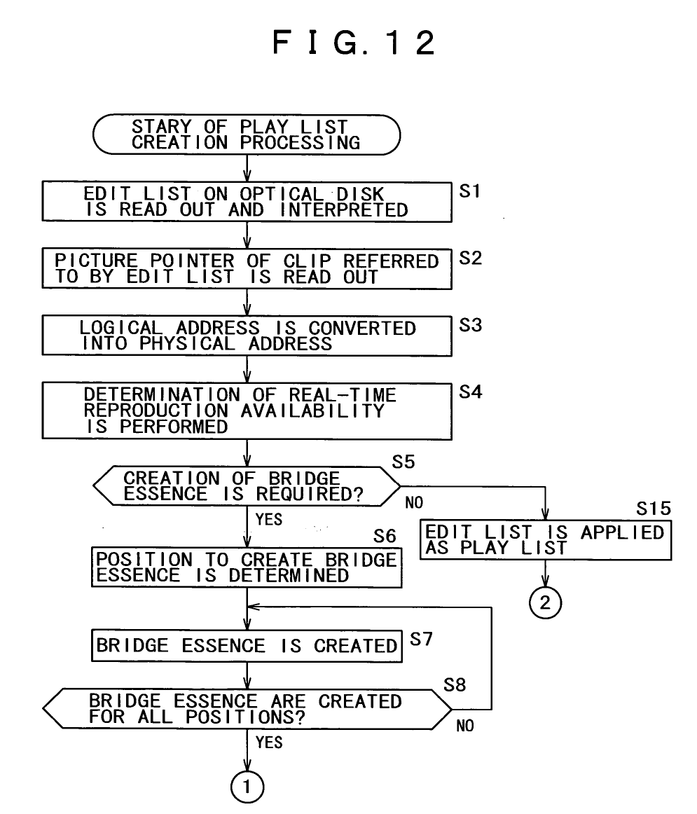

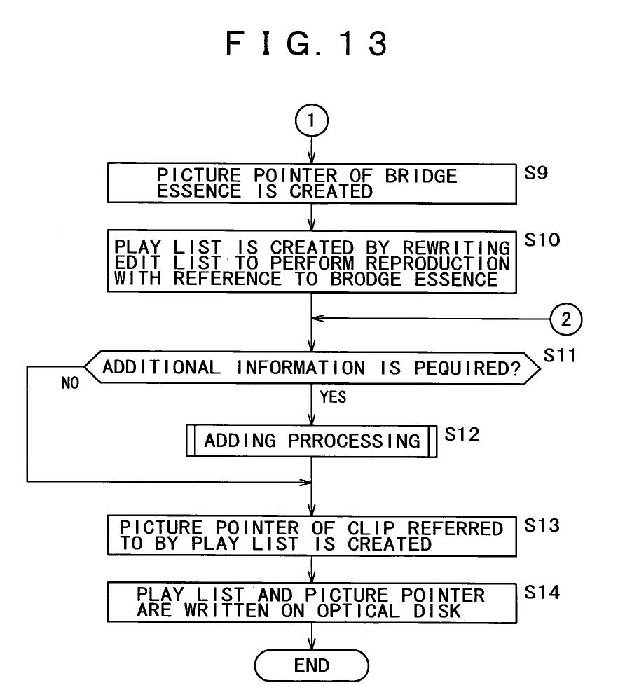

First of all, a Play List creation processing performed with the disk apparatus 1 of FIG. 2 is described with reference to flowcharts of FIGS. 12 and 13.

This processing is started, for instance, when a selection of the prescribed Edit List to be converted into the Play List among the recorded Edit lists is made through the user after the optical disk 52 containing the image data and the Edit Lists etc. is placed in the drive 12.

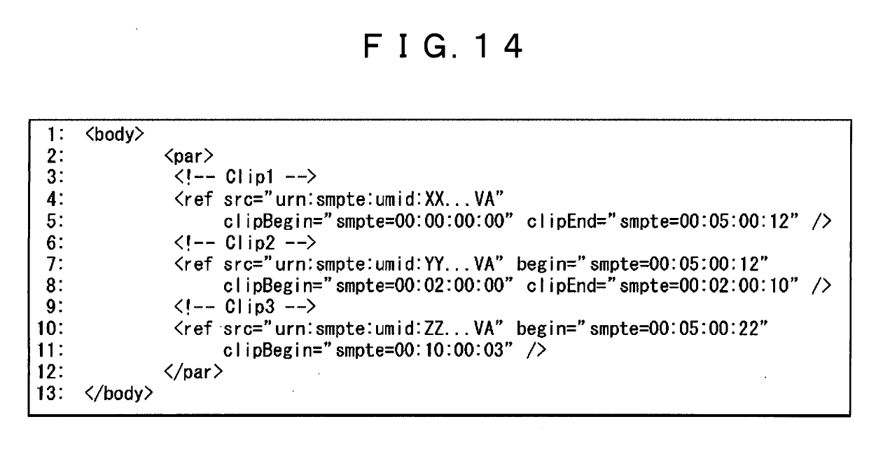

In Step S1, the Edit List readout unit 42 reads out the Edit List recorded on the optical disk 52 and interprets the Edit List. Specifically, the Edit List readout unit 42 reads out the Edit List as shown in FIG. 14, for instance, and converts the Edit List into a format adaptable to be processed with the information processing unit 11.

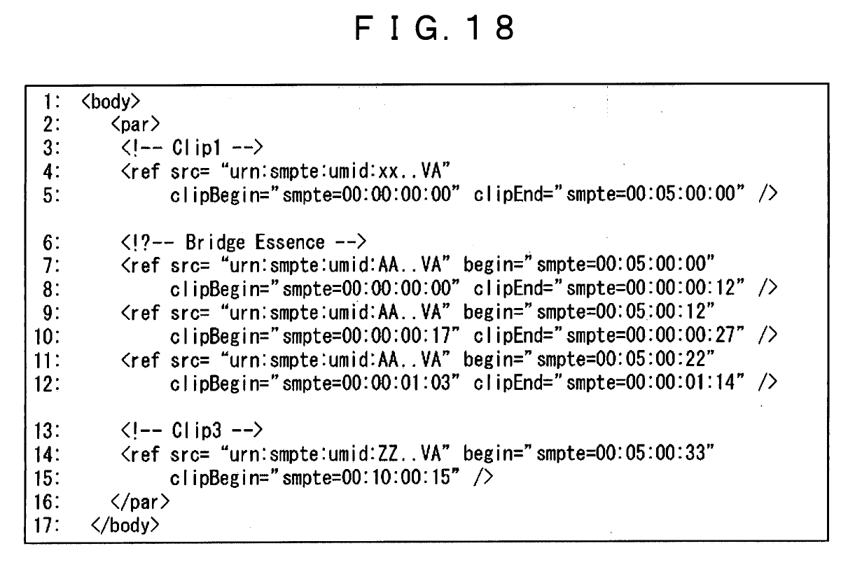

FIG. 14 illustrates an embodiment of codes in a specific range headed by <body> tag as a head tag and ended by </body> tag as an end tag. Incidentally, in FIG. 14, numeric characters and colon symbols (:) at the head of lines are those merely appended for the convenience of a description, in other words, are not the part of codes. The same is also applied to FIGS. 18, 19, 26, 32, 35 and 37 respectively described later.

As described above, the Edit List is to express the edit point position (the time code), and a description of contents thereof is given between <par> tag in the second line and </par> tag in the twelfth line.

[<!--Clip1-->] in the third line indicates that codes relating to the Clip #1 are described in the fourth and the fifth lines following the third line.

[ref src = “urn : smpte : umid : XX. . .VA]out of [<ref src = “urn : smpte : umid : XX. . .VA clipBegin = “smpte = 00:00:00:00” clipEnd = “smpte = 00:05:00:12”/>] in the fourth and the fifth lines indicates that [umid : XX. . .VA] (a file name of the Clip #1) defined by SMPTE (Society of Motion Picture and Television Engineers) is assumed to be the object of reproduction. Further, [clipBegin = “smpte = 00:00:00:00”] indicates that the IN point of the Clip #1 is set at [TC = 00:00:00:00], and [clipEnd = “smpte = 00:05:00:12”] indicates that the OUT point of the Clip #1 is set at [TC = 00:05:00:12].

An umid (unique material identifier) used herein represents a worldwide unique ID set at the reference data. An umid (UMID) includes Basic UMID and Extended UMID, wherein the Basic UMID is applied as a unique ID of the image data etc. Also, the Extended UMID represents a source pack (a time, a location and an image-capturing user etc.), and is added to the Basic UMID for indication of a video image character or application to retrieval.

[<!--Clip2-->] in the sixth line indicates that codes relating to the Clip #2 are described in the seventh and the eighth lines following the sixth line.

[<ref src = “urn : smpte : umid : YY. . .VA] out of [<ref src = “urn : smpte : umid : YY. . .VA begin = “smpte = 00:05:00:12”clipBegin = “smpte = 00:02:00:00”clipEnd = “smpte = 00:02:00:10”/>] indicates that a file name of the Clip #2 is [umid : YY. . .VA], and [begin = “smpte = 00:05:00:12”] indicates that the display of the Clip #2 is started with [TC = 00:05:00:12].

Further, [clipBegin = “smpte = 00:02:00:00”] indicates that the IN point of the Clip #2 is set at [TC = 00:02:00:10], and [clipEnd = “smpte = 00:02:00:10”] indicates that the OUT point of the Clip #2 is set at [TC = 00:02:00:10].

[<!--Clip3-->] in the ninth line indicates that codes relating to the Clip #3, are described in the tenth and the eleventh lines following the ninth line.

[<ref src = “urn : smpte : umid : ZZ. . .VA] out of [<ref src = “urn: smpte : umid: ZZ. . .VA begin = “smpte = 00:05:00:22” clip Begin = “smpte = 00:10:00:03”/>] in the tenth and the eleventh lines indicates that a file name of the clip #3 is [umid : ZZ. . .VA], and [begin = “smpte = 00:05:00:22”] indicates that the display of the Clip #3 is started with [TC = 00:05::00:22].

Further, [clipBegin = “smpte = 00:10:00:03”] indicates that the IN point of the Clip #3 is set at [TC = 00:10:00:03].

As described above, the Edit List recorded on the optical disk 52 and the Play List created therefrom are described in a prescribed edit description language such as XML base language, for instance.

The read-out Edit List is outputted from the Edit List readout unit 42 to the picture pointer readout unit 41, after being converted into a prescribed format.

In Step S2, the picture pointer readout unit 41 reads out, from the optical disk 52 based on the Edit List supplied from the Edit List readout unit 42, a picture pointer of the Clip referred to by the supplied Edit List. The picture pointer readout unit 41 acquires the picture pointers of the Clips #1 to #3, for instance, when the Edit List of FIG. 14 that refers to the Clips #1 to #3 was supplied from the Edit List readout unit 42.

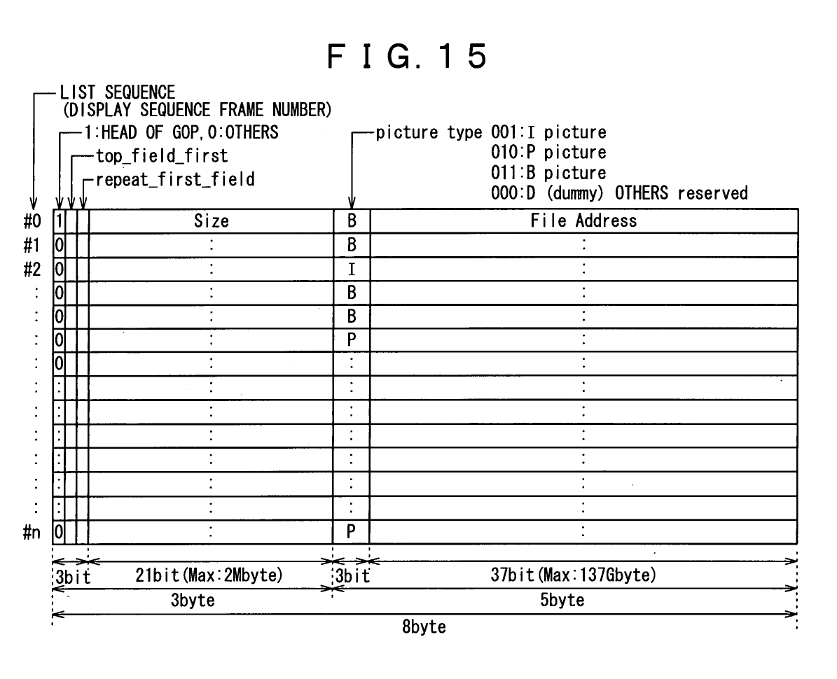

FIG. 15 illustrates an embodiment of the picture pointer.

Table information as shown in FIG. 15 is created as the picture pointer for each Clip, for instance, at the time of recording (encoding) of the image data, and is then recorded on the optical disk 52. This table is composed of a plurality of entries (columns), and each entry is arranged to be of a fixed size. In the embodiment of FIG. 15, each entry is arranged to have a size of 8 bytes.

Information of one picture is recorded on one entry. The information of each picture is recorded in the display sequence on each entry.

A GOP head flag, a top_field_first flag and a repeat_first_field flag are recorded as the information of each picture bit by bit at the head of the information of each picture. In FIG. 15, [1] of the GOP head flag indicates that a given picture is a head picture of a GOP, and [0] indicates that the given picture is not the head picture of the GOP.

Next to the above three flags, a data size of each picture is recorded in 21 bits.

Further, next to the size, a picture type is described in 3 bits. [001] of the picture type indicates that the given picture is of the I picture type, [010] indicates that the given picture is of the P picture type, and [011] indicates that the given picture is of the B picture type. Then, [000] indicates that the given picture is a dummy picture.

Further, next to the picture type, a head file address of the given picture (the logical address) is described in 37 bits.

The read-out picture pointer is outputted from the picture pointer readout unit 41 to the real-time reproduction availability determination unit 24 together with the Edit List.

Each picture physical address on the optical disk 52 is required to determine whether or not the reproducing apparatus 101 is capable of real-time reproduction of the image data. Thus, the real-time reproduction determination unit 24 outputs, to the address management unit 23, the file address (the logical address) described in the picture pointer supplied from the picture pointer readout unit 24.

In Step S3, the address management unit 23 converts the logical address supplied from the real-time reproduction availability determination unit 24 into the physical address and outputs the resultant physical address to the real-time reproduction availability determination unit 24.

The real-time reproduction availability determination unit 24 acquires the physical address (each picture physical address) supplied from the address management unit 23 and determines in Step S4 whether or not the reproducing apparatus 101 is capable of reproducing, in real time, the image data referred to by the Edit List according to the edit point thereof (a determination of real-time reproduction availability is performed). The determination of real-time reproduction availability is performed for all of seek generating positions.

At this time, the supply of the information on the reproducing apparatus 101, such as the buffer capacity and the decode speed, from the device information storage unit 25 to the real-time reproduction availability determination unit 24 is completed, and the above information is applied to the determination of real-time reproduction availability.

In Japanese Patent Application Nos. 2002-366197 and 2002-366199, the details of the determination of real-time reproduction availability are stated. It is also allowable to apply a technology stated in each of these documents to the determination of the real-time reproduction availability with the disk apparatus 1 of FIG. 2. Alternatively, it is of course allowable to apply, to the determination of real-time reproduction availability, various methods, such as one in which after virtual reproduction of the image data under the same conditions as those used in the reproducing apparatus 101, the real-time reproduction availability determination unit 24 determines whether or not the above reproduction is being processed in real time.

In Step S5, the real-time reproduction availability determination unit 24 determines, based on the result of the determination of real-time reproduction availability, whether or not the creation of the Bridge Essence is required.

As described above with reference to FIGS. 3A and 3B, when it is determined that the reproducing apparatus 101 fails to perform the real-time reproduction according to the Edit List because of the presence of the large length of the seek time, the real-time reproduction availability determination unit 24 determines in Step S5 that the creation of the Bridge Essence is required, and the processing moves on to Step S6. At this time, the information such as the Edit List, the picture pointer and each picture physical address is outputted to the Bridge Essence creation unit 26 through the control unit 22.

In Step S6, the Bridge Essence creation unit 26 determines a position to create the Bridge Essence, based on the result of the determination of real-time reproduction availability.

In Step S7, the Bridge Essence creation unit 26 creates the Bridge Essence of GOP units, for instance, at the position determined in Step S6.

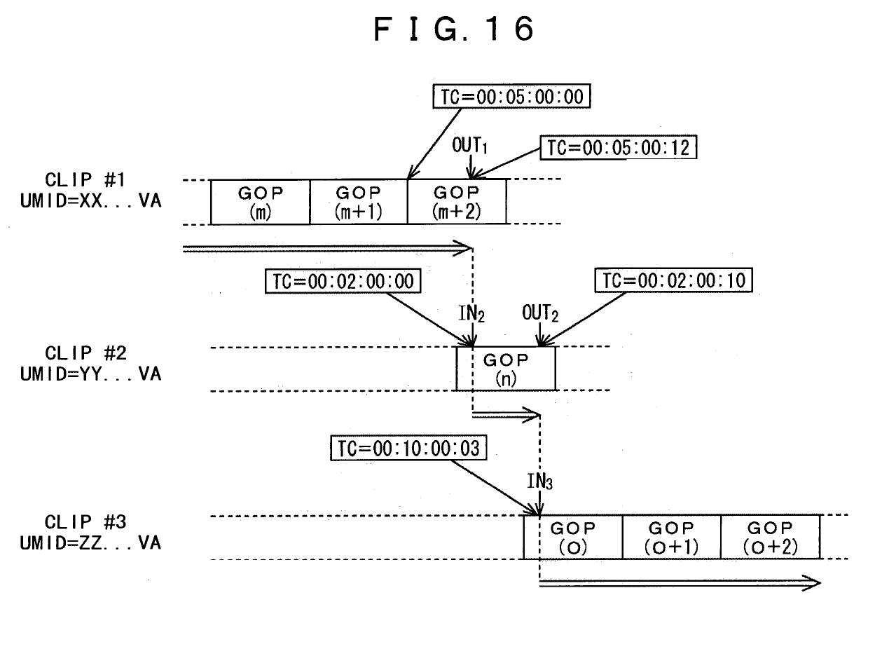

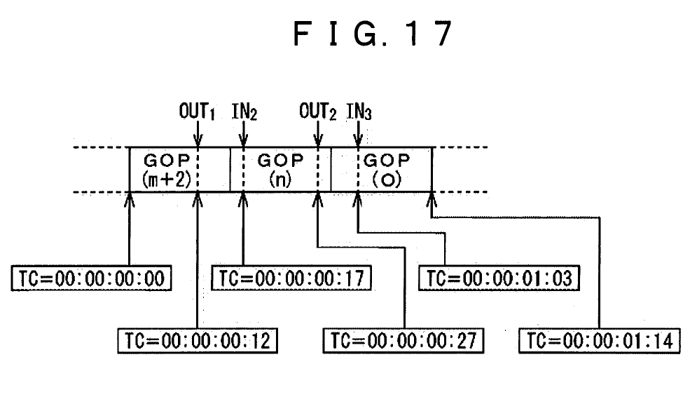

FIGS. 16 and 17 illustrate the creation of the Bridge Essence.

A hollow-shaped arrow in FIG. 16 indicates the video image display sequence. Specifically, it is assumed that the display of the pictures in the range of a certain GOPᵢ to the picture at the OUT₁ point of the GOP(m+2) takes place, and the display thereof in the range of the picture at the IN₂ point to the posterior picture at the OUT₂ point thereto of the GOP(n) follows, and is further followed by the display thereof in the range of the picture at the IN₃ point of the GOP(0) to a prescribed picture of the following GOPⱼ.

In FIG. 16, when the start position (the head position of the file adapted to storage of the Clip #1) of the GOPᵢ is specified as [TC = 00:00:00:00], the head of the GOP(m+2) is expressed by [TC = 00:05:00:00]. Further, the OUT₁ point is set at [TC = 00:05:00:12], the IN₂ point is set at [TC = 00:02:00:00], the OUT₂ point is set at [TC = 00:02:00:10], and the IN₃ point is set at [TC = 00:10:00:03], respectively. Thus, the IN₂ point and the OUT₂ point are placed anterior to the OUT₁ point, and the IN₃ point is placed posterior to the OUT₁ point.

Specifically, the above display is based on the Edit List shown in FIG. 4.

When it is determined by the real-time reproduction availability determination unit 24 that the reproducing apparatus 101 fails to perform the real-time reproduction of the Clips in the sequence indicated by the hollow-shaped arrow in FIG. 16 because of the presence of the large length of the seek time from the OUT₁ point to the IN₂ point or from the OUT₂ point to the IN₃ point, for instance, the Bridge Essence creation unit 26 creates, in the blank area of the optical disk 52, the Bridge Essence composed of the GOP(m+2) of the Clip #1, the GOP(n) of the Clip #2 and the GOP(0) of the Clip #3, as shown in FIG. 17.

In FIG. 17, when the head (the head of the file adapted for storage of the Bridge Essence of FIG. 17) of the GOP(m+2) is specified as [TC = 00:00:00:00], the OUT₁ point at the GOP(m+2) is expressed by [TC = 00:00:00:12], and the IN₂ point and the OUT₂ point at the GOP(n) are expressed by [TC = 00:00:00:17] and [TC = 00:00:00:27], respectively. Further, the IN₃ point set at the GOP(0) is expressed by [TC = 00:00:01:03], and the end position of the GOP(0) is expressed by [TC = 00:00:01:14].

As described above, the Bridge Essences are created for all the positions (the positions where the large seek time arises) having been determined as the positions to be created the Bridge Essence, and the Edit List is rewritten so as to perform the reproduction of the image data with reference to the created Bridge Essence.

The created Bridge Essence is outputted from the Bridge Essence creation unit 26 to the writing unit 31, and is then written onto the optical disk 52 through the disk I/F 51. Further, the information such as the position to create the Bridge Essence and the Bridge Essence file name is outputted, as the Bridge Essence-related information, to the Play List creation unit 28 and the picture pointer creation unit 29.

The Bridge Essence creation unit 26 determines in Step S8 whether or not the creation of the Bridge Essences for all the positions is completed. When it is determined that the above creation is not completed, the processing moves back to Step S7 to create the Bridge Essence for each of the required positions.

When it is determined in Step S8 that the creation of the Bridge Essences for all the positions is completed, the processing moves on to Step S9, wherein the picture pointer creation unit 29 creates the picture pointer of the Bridge Essence. Specifically, the picture pointer creation unit 29 extracts, from the picture pointer (the picture pointer read out with the picture pointer readout unit 41, as the picture pointer of the Clip referred to by the Edit List) supplied from the control unit 22, only the information relating to the pictures contained in the Bridge Essence, and also specifies the extracted information as the Bridge Essence picture pointer. Incidentally, the Bridge Essence picture pointer created herein is that contained in the Play List picture pointer created in Step S13.

In Step S10, the Play List creation unit 28 creates the Play List by rewriting the Edit List supplied from the control unit 22 so as to perform the reproduction with reference to the Bridge Essence.

FIG. 18 illustrates an embodiment of a Play List obtained by rewriting the Edit List of FIG. 14 so as to be referred to the Bridge Essence of FIG. 17. A description on portions overlapping with those in FIG. 14 is omitted appropriately.

The third to the fifth lines of FIG. 18 describe codes relating to the Clip #1 (Clip 1), and the sixth to the twelfth lines describe codes relating to a newly created Bridge Essence. Further, the thirteenth to the fifteenth lines describe codes relating to the Clip #3 (Clip 3). In other words, in the Play List, the newly created Bridge Essence is assumed to be the object of reproduction.

Specifically, [<ref src = “urn : smpte : umid : XX. . .VA clipBegin = “smpte = 00:00:00:00” clipEnd = “smpte = 00:05:00:00”/>] in the fourth and the fifth lines indicates that the Clip #1 specified by [umid : XX. VA] is reproduced to display the pictures from [TC = 00:00:00:00] to [TC = 00:05:00:00] (in the range of the non-illustrated GOPi to the last picture of the GOP(m+1) in FIG. 16).

[<!?--Bridge Essence-->] in the sixth line indicates that the codes relating to the Bridge Essence are described in the seventh to the twelfth lines following the sixth line.

[<ref src = “urn : smpte : umid : AA. . .VA begin = “smpte = 00:05:00:00”] in the seventh line indicates that the display of the Bridge Essence specified by [umid : AA. . .VA]is started with [TC = 00:05:00:00].

[clipBegin = “smpte = 00:00:00:00” clipEnd = “smpte = 00:00:00:12”/] in the eighth line indicates that the reproduction is performed, based on the prescribed position within the Bridge Essence, to display the pictures from [TC = 00:00:00:00] to [TC = 00:00:00:12] (in the range of the head to the picture at the OUT₁ point of the GOP(m+2) contained in the Bridge Essence (FIG. 17)).

[<ref src = “urn : smpte : umid : AA. . .VA begin = “smpte = 00:05:00:12”] in the ninth line indicates that the display in the range specified by the code in the tenth line is started with [TC = 00:05:00:12].

[clipBegin = “smpte = 00:00:00:17” clipEnd = “smpte = 00:00:00:27”/] in the tenth line indicates that the reproduction is performed, based on the prescribed position within the Bridge Essence, to display the pictures from [TC = 00:00:00:17] to [TC = 00:00:00:27] (in the range of the picture at the IN₂ point to the picture at the OUT₂ point contained in the Bridge Essences (FIG. 17)).

[<ref src = “urn : smpte : umid : AA. . .VA begin = “smpte = 00:05:00:22”] in the eleventh line indicates that the display in the range specified by the code in the twelfth line is started with [TC = 00:05:00:22].

[clipBegin = “smpte = 00:00:01:03” clipEnd = “smpte = 00:00:01:14”/]in the twelfth line indicates that the reproduction is performed, based on the prescribed position within the Bridge Essence, to display the pictures from [TC = 00:00:01:03]to [TC = 00:00:01:14] (in the range of the picture at the IN₃ point contained in the Bridge Essence to the last picture of the GOP(O), (FIG. 17)).

The created Play List is outputted from the Play List creation unit 28 to the picture pointer creation unit 29 and the writing unit 31.

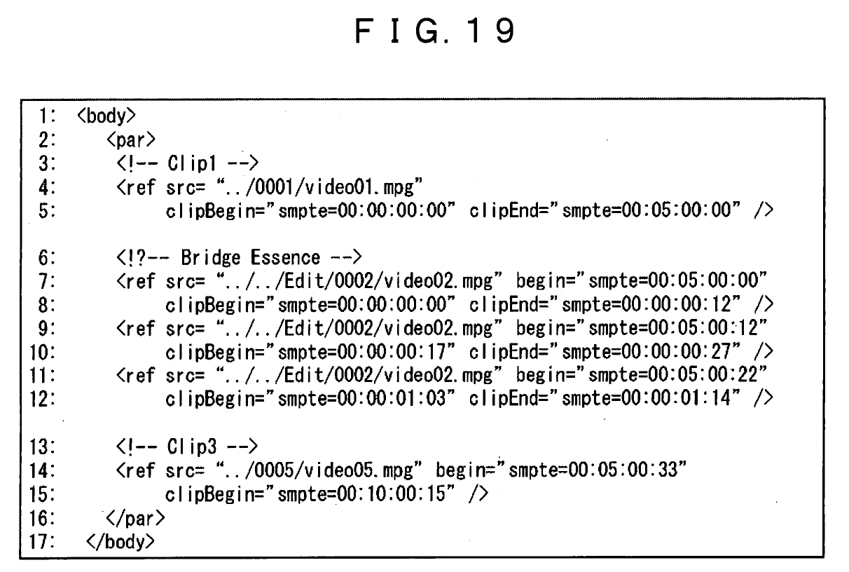

FIG. 19 illustrates a different embodiment of the Play List created based on the Edit List of FIG. 14. The Play List of FIG. 19 has a different file reference format, as compared with the Play List of FIG. 18.

Specifically, in the Play List of FIG. 19, the Clip #1 is specified by [“. ./0001/video01.mpg”] in the fourth line thereof, and the Bridge Essence is specified by [“. ./. ./Edit/0002/video02.mpg”] in the seventh, the ninth and the eleventh lines thereof. Further, the Clip #3 is specified by [“. ./0005/video05.mpg”] in the thirteenth line. As described above, the Play List creation unit 28 may also provide a description of the Play List so as to specify the Clip in various formats.

Referring to the description with reference to FIG. 13 again, in Step S11, the Play List creation unit 28 determines whether or not it is necessary to add, to the Play List created in Step S10, the additional information created with the additional information creation unit 27. When it is determined that it is necessary to add the additional information, the processing moves on to Step S12.

In Step S12, the Play List creation unit 28 adds the additional information created with the additional information creation unit 27. As described later, the schedule information and the decoder specifying information etc. are added as the additional information, for instance.

Conversely, in Step S11, when it is determined that it is not necessary to add the additional information, Step S12 is skipped.

In Step S13, the picture pointer creation unit 29 creates the picture pointer of the Clip referred to by the Play List. The picture pointer creation unit 29 adds, to the picture pointer of the Bridge Essence created in Step S9, the picture pointer of the Clip referred to by the Play List, that is, the picture pointer of the Clip other than the Bridge Essence, and also applies the obtained picture pointer as the Play List picture pointer. The created picture pointer is outputted to the writing unit 31.

In Step S14, the writing unit 31 writes, onto a prescribed area of the optical disk 51 through the disk I/F 51, the Play List supplied from the Play List creation unit 28 and the picture pointer supplied from the picture pointer creation unit 29, thereby bringing the processing to an end.

Conversely, in Step S5 of FIG. 12, when it is determined that the creation of the Bridge Essence is not required, the processing moves on to Step S15, wherein with the Edit List applied as the Play List, the processing on and after Step S11 follows. Specifically, when the reproducing apparatus 101 is capable of real-time reproduction of the image data according to the Edit List, the Play List is created so as to apply intact the Clip referred to by the Edit list as the object of reproduction, without creating the Bridge Essence.

As described above, in the case of the reproduction of the image data, the processing of creating the Play List so as to ensure the real-time efficiency of the reproduction of the image data, and then providing the Play List for the reproducing apparatus 101 is taken, so that the reproduction of the image data according to the created Play List in the reproducing apparatus 101 may avoid the freeze caused by the presence of the long length of the seek time.

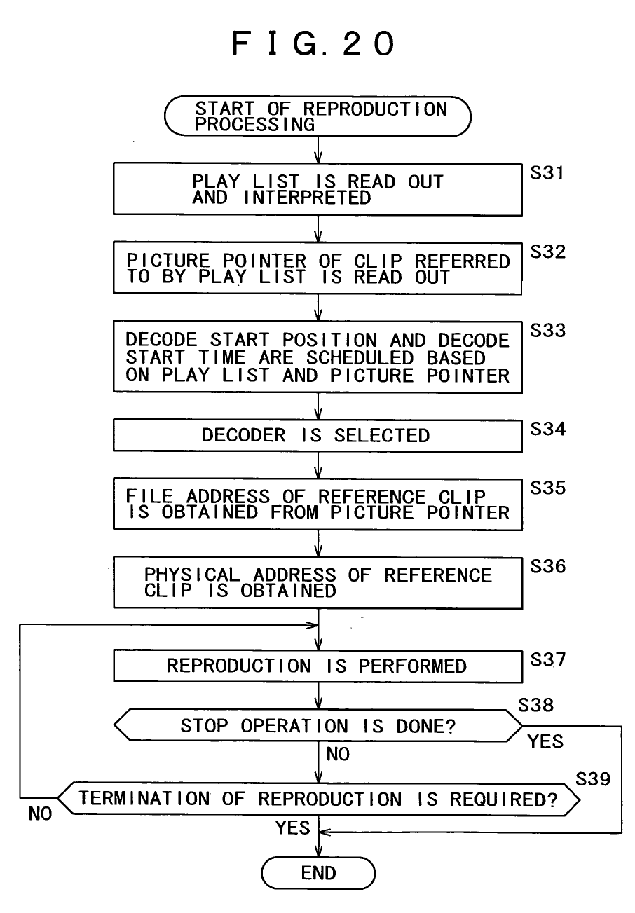

A processing of the reproducing apparatus 101 available for the reproduction of the image data based on the Play List created with the processing of FIGS. 12 and 13 is next described with reference to a flowchart of FIG. 20.

When a command to reproduce the image data according to the Play List is issued after the optical disk 52 containing the Play List is placed in the drive 112, the Play List readout unit 132 reads out, in Step S31, the Play List from the optical disk 52 and interprets the Play List by means of conversion into an internally processable format. The read-out and interpreted Play List is outputted from the Play List readout unit 132 to the picture pointer readout unit 131.

The Play List of FIG. 18 or 19 is read out, for instance, from the Play List readout unit 132.

In Step S32, the picture pointer readout unit 131 reads out, from the optical disk 52, the picture pointer of the Clip referred to by the Play List. The read-out picture pointer is outputted from the picture pointer readout unit 131 to the decode scheduling unit 123 together with the Play List.

In Step S33, the decode scheduling unit 123 schedules the decode start position and the decode start time of the image data based on the Play List and the picture pointer supplied from the picture pointer readout unit 131.

Specifically, the decode scheduling unit 123 detects the picture at the edit point (IN point) from the Play List to acquire the picture type of the detected picture from the picture pointer. Further, as described above with reference to FIGS. 8 and 9 etc., the decode scheduling unit 123 also acquires the number of pictures to be decoded before the picture at the edit point is decoded, and then determines the decode start position (the picture) and the decode start time based on the acquired number of pictures.

In Step S34, the decode scheduling unit 123 also selects the decoder available for decoding with the decoder selection unit 133.

In Step S35, the decode scheduling unit 123 acquires, from the picture pointer, the file address of the Clip referred to by the Play List. In Step S36, the decode scheduling unit 123 also makes inquiries at the address management unit 122 to acquire each picture physical address corresponding to the file address.

The information acquired with the decode scheduling unit 123, such as the schedule information representing the scheduling result, the decoder specifying information and the physical address of the reference Clip, is outputted to the decoder control unit 124.

In the reproducing apparatus 101 of FIG. 6, the scheduling (Step S33) of the decode start position and the decode start time, the selection (Step S34) of the decoder and the acquisition (Step S36) of the physical address mainly take place as a preprocessing for the reproduction of the image data.

In Step S37, the decoder control part 124 controls the decoders 155₁ and 155₂ according to the schedule information and the decoder specifying information to permit the reproduction of the image data.

In Step S38, the decoder control part 124 determines whether or not a stop operation is done through the user. When it is determined that the stop operation is not done, the processing moves on to Step S39, wherein it is subsequently determined whether or not a termination of the reproduction of the image data based on the Play List is required.

When it is determined in Step S39 by the decoder control part 124 that the termination of the reproduction is not required, the processing moves back to Step S37, wherein the processing on and after Step S37 follows. Conversely, when it is determined that the termination of the reproduction is required, the processing is brought to an end. Incidentally, when it is determined in Step S38 that the stop operation is done, the processing is also brought to the end, likewise.

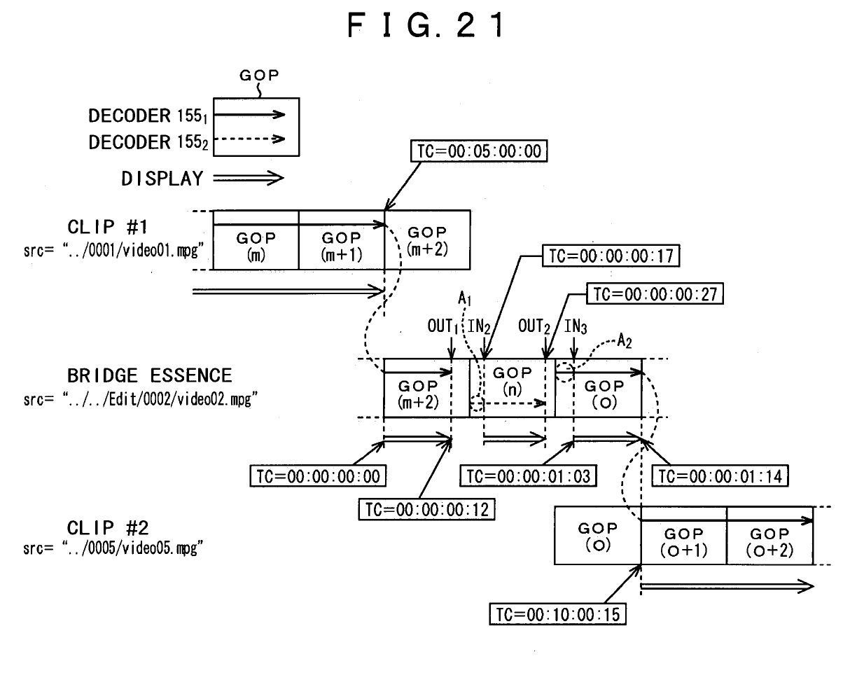

FIG. 21 illustrates the image data reproduction performed in Step S37 when the Play List of FIG. 19 is provided.

In FIG. 21, the display sequence is indicated by a hollow-shaped arrow, the decode processing (the reproduction) with the decoder 155₁ is indicated by a solid arrow on the image data (GOP), and the decode processing with the decoder 155₂ is indicated by a broken arrow on the image data, respectively.

According to the description in the fourth and the fifth lines of FIG. 19, the pictures from [TC = 00:00:00:00] to [TC = 00:05:00:00] (in the range of the head of the GOPᵢ to the last picture of the GOP(m+1)) of the Clip #1 specified by [“. ./0001video01.mpg”] are decoded with the decoder 155₁ selected in the above processing (Step S34), for instance, as shown in FIG. 21.

Following the decode processing (in [TC = 00:05:00:00)]) of the last picture of the GOP(m+1), the pictures from [TC = 00:00:00:00] to [TC = 00:00:00:12] (in the range of the first picture to the picture at the OUT₁ point of the GOP(m+2)), within the Bridge Essence specified by [“. ./. ./Edit/0002/video02.mpg”] are decoded with the decoder 155₁ according to the description in the seventh and the eighth lines of FIG. 19.

Incidentally, when [TC = 00:00:00:00] specified as the reproduction start position of the Clip #1 is assumed to be the reference, the OUT₁ point is specified by [TC = 00:05:00:12] obtained by adding a period ([00:00:00:12]) from the head to the OUT₁ point of the GOP(m+2) in the Bridge Essence to [TC = 00:05:00:00] at which the last picture of the GOP(m+1) is decoded over.

Following the decode processing (in [TC = 00:05:00:12]) of the picture at the OUT₁ point, the pictures from [TC = 00:00:00:17] to [TC = 00:00:00:27] (in the range of the picture at the IN₂ point to the picture at the OUT₂ point of the GOP(n)) are decoded with the decoder 155₂, for instance, according to the description in the ninth and the tenth lines of FIG. 19.

A range A₁ of FIG. 21 indicates a range where the pictures (the non-displayed pictures temporally anterior to picture at the IN₂ point) within that range are decoded with the decoder 155₂. As describe dabove, the real-time reproduction requires that the non-displayed picture be decoded with the decoder 155₂ before the picture at the IN₂ point is decoded.

Incidentally, when the reproduction start position of the Clip #1 is assumed to be the reference, the OUT₂ point is specified by [TC = 00:05:00:22] obtained by adding a period ([00:00:00:10]) from the IN₂ point to the OUT₂ point of the GOP(n) in the Bridge Essence to [TC = 00:05:00:12] at which the OUT₁ point is set.

Following the decode processing (in [TC = 00:05:00:22]) of the picture at the OUT₂ point, the pictures from [TC = 00:00:01:03] to [TC = 00:00:01:14] in the range of the picture at the IN₃ point of the GOP(0) to the last picture of the GOP(n)) are decoded with the decoder 155₁, for instance, according to the description in the eleventh and the twelfth lines of FIG. 19.

A range A₂ of FIG. 21 indicates a range where the pictures (the non-displayed pictures temporally anterior to the picture at the IN₃ point) within that range are decoded with the decoder 155₁ before the picture at the IN₃ point is decoded.

Incidentally, when the reproduction start position of the Clip #1 is assumed to be the reference, the last of the GOP(0) is specified by [TC = 00:05:00:33] obtained by adding a period ([00:00:00:11]) from the IN₃ point to the OUT₃ point of the GOP(0) in the Bridge Essence to [TC = 00:05:00:22] at which the OUT₂ point is set.

Following the decode processing (in [TC = 00:05:00:33]) of the Bridge Essence, the pictures from [TC = 00:10:00:00] (from the first picture of GOP(n+1)) of the Clip #3 to a prescribed picture posterior thereto are decoded with the decoder 155₁, for instance, according to the description in the fourteenth and the fifteenth lines of FIG. 19.

The decode processing is performed in this manner to display the respective pictures on the display 157. Incidentally, output to the display 157 is appropriately switched with the switcher 156 in linkage with a decode switching operation.

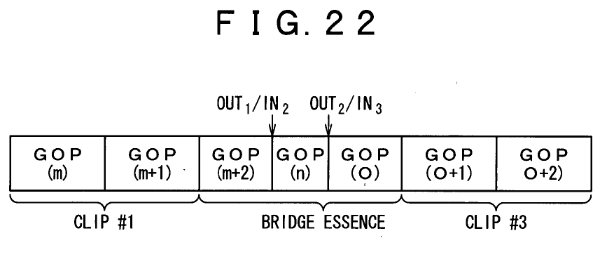

FIG. 22 illustrates the display on the display 157.

As shown in FIG. 22, the displayed image whose real-time efficiency is ensured is provided by means of decoding with reference to the Bridge Essence according to the Play List of FIG. 19 or by starting decoding with the prescribed position before the display of the picture at the edit point depending on the picture at the edit point.

Specifically, as shown in FIG. 22, there is provided the continuous display of the non-destructive edited pictures (the pictures in the range indicated by the hollow-shaped arrow of FIG. 16) assumed to be the object of reproduction among the Clip #1, the Clip #3 and the Bridge Essence, without causing the breaking.

The processing with the disk apparatus 1 and the reproducing apparatus 101 as described above enables the user as an editing user to perform the editing without being conscious of whether or not the real-time reproduction of the image data as the editing result is possible.

Further, in the creation of the Bridge Essence, neither decode processing nor re-encode processing etc. is required, so that the quality of the video image displayed with reference to the Bridge Essence may be prevented from degradations.

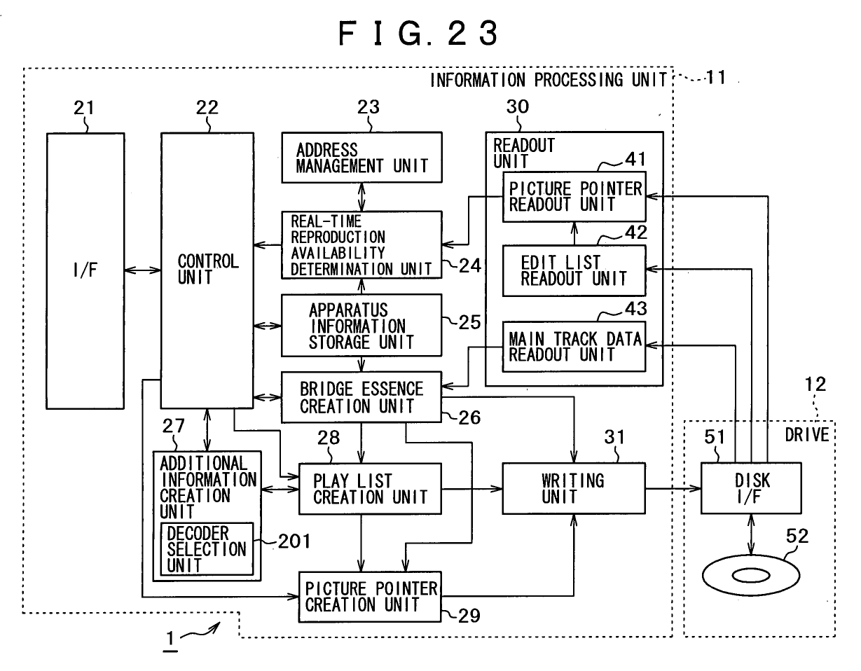

FIG. 23 is a block diagram showing a different embodiment of the configuration of the disk apparatus 1. In FIG. 23, the same units as those in FIG. 2 are designated by the like reference numerals, and a description thereof is omitted appropriately.

The disk apparatus 1 of FIG. 23 has the additional information creation unit 27 having a decoder selection unit 201, unlike the disk apparatus 1 of FIG. 2.

The decoder selection unit 201 creates the decoder specifying information as the additional information on based on the Bridge Essence-related information supplied from the Bridge Essence creation unit 26 through the control unit 22 and the picture pointer and the device information etc. on the reproducing apparatus 101, such as the number of decoders, supplied from the control unit 22, and supplies the decoder specifying information to the Play List creation unit 28.

Specifically, while the above embodiment is arranged to, at the time of reproduction of the image data, apply the reproducing apparatus 101 itself to select the decoder (Step S34 of FIG. 20) as the preprocessing of the reproduction of the image data, this embodiment is modified such that the decoder available for decoding is selected in advance with the disk apparatus 1, and the decoder specifying information is contained in the Play List.

Thus, the reproducing apparatus 101 may start the reproduction processing quickly without performing the selection of the decoder as the preprocessing at the time of reproduction of the image data.

Further, in the case of the creation of the Bridge Essence, the GOP contained in the Bridge Essence is preferably decoded with the same decoder as that used for decoding the Clip that has been contained before a rearrangement as the GOP contained in the Bridge Essence.

For instance, it is preferable that the GOP(m+2) contained in the Bridge Essence shown in FIG. 21 is decoded with the decoder 155, used for decoding the Clip #1 that has been contained before the rearrangement as the GOP contained in the Bridge Essence. This is because the last picture of the GOP(m+1) and the first picture of the GOP(m+2) are essentially contained in a continuous video image, in which case use of the different decoders for decoding these pictures leads to a loss of video image continuity in a decoder switch point.

Thus, the degradations of the image quality may be prevented by decoding the image data (the Bridge Essence) according to the Play List containing the decoder specifying information created with the disk apparatus 1 applied as a Bridge Essence creating apparatus.

The Play List creation unit 28 creates, based on the decoder specifying information supplied from the decoder selection unit 201, the Play List containing a decoder specifying code. The created Play List is provided for the reproducing apparatus 101 after being recorded on the optical disk 52.

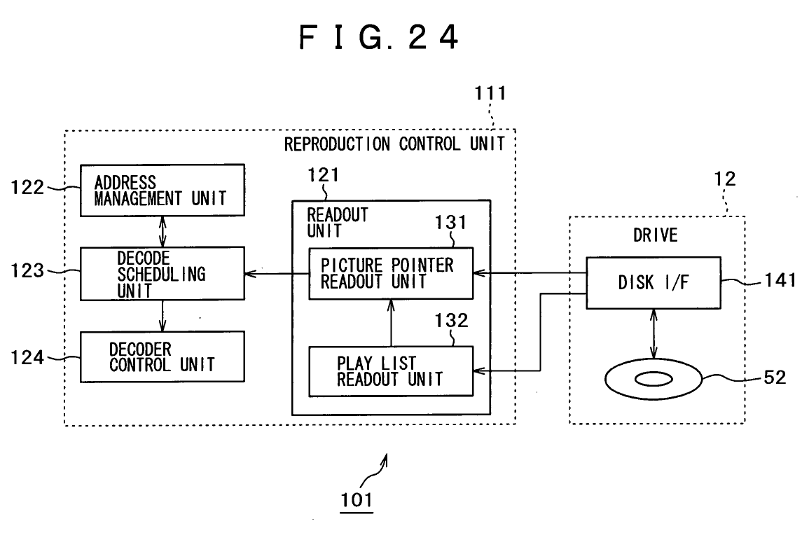

FIG. 24 is a block diagram showing a different embodiment of the configuration of the reproducing apparatus 101.

The reproducing apparatus 101 of FIG. 24 is to reproduce the image data according to the Play List created with the disk apparatus 1 of FIG. 23.

The Play List created with the disk apparatus 1 of FIG. 23 contains the decoder specifying information, so that the reproducing apparatus 101 does not need to select the decoder available for decoding at the time of reproduction of the image data. Thus, the reproducing apparatus 101 of FIG. 24 has the decode scheduling unit 123 having no decoder selection unit 133, unlike the reproducing apparatus of FIG. 6.

Other configurations of the reproducing apparatus 101 of FIG. 24 are similar to those of FIG. 6. Specifically, the decode scheduling is performed with the decode scheduling unit 123 based on the Play List and the picture pointer supplied from the picture pointer readout unit 131, and the result of decode scheduling is outputted to the decoder control unit 124. A description of the other configurations similar to those shown in FIG. 6 is omitted.

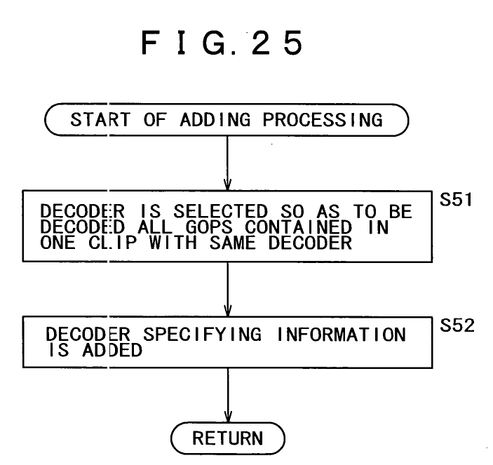

A decoder specifying information adding processing performed with the disk apparatus 1 of FIG. 23 is now described with reference to a flowchart of FIG. 25.

This processing is started at Step S12 included in the Play List creation processing as described above with reference to FIGS. 12 and 13, that is, when it is determined in Step S11 that the additional information is required for the creation of the Play List.

When a request of the additional information is issued from the Play List creation unit 28, the decoder selection unit 201 selects, in Step S51, the decoder available for decoding each Clip so as to be decoded all the GOPs contained in one Clip with the same decoder.

The decoder specifying information as the decoder selection result is outputted to the Play List creation unit 28.

In Step S52, the Play List creation unit 28 adds, based on the decoder specifying information supplied from the decoder selection unit 201, the decoder specifying information to the Play List created in Step S10 of FIG. 12.

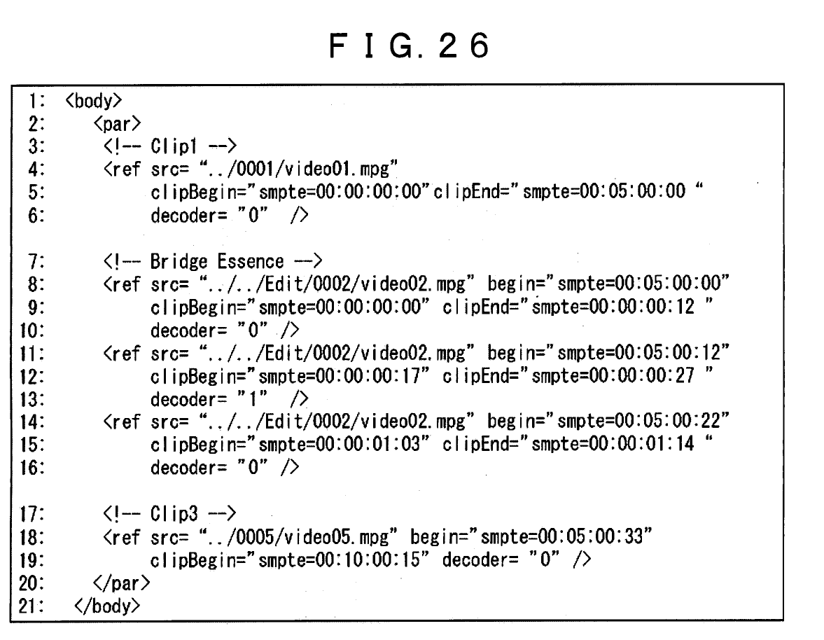

FIG. 26 illustrates an embodiment of the Play List containing the decoder specifying information added through the processing of FIG. 25.

The Play List of FIG. 26 is similar to the Play List of FIG. 19, except that the former Play List contains a decoder specifying description added to the sixth, the tenth, the thirteenth, sixteenth and the nineteenth lines.

In FIG. 26, [decoder = “0”] as the decoder specifying description specifies that the Clip #1 additionally containing the above description is decoded with the decoder 155₁ out of the two decoders of the reproducing apparatus 101, and [decoder = “1”] specifies that the Clip #1 is decoded with the decoder 155₂.

[decoder = “0”] in the sixth line of FIG. 26 specifies that the pictures from [TC = 00:00:00:00] to [TC = 00:05:00:00] of the Clip #1 specified by the codes in the fourth and the fifth lines are decoded with the decoder 155₁.

[decoder = “0”] in the tenth line specifies that the pictures from [TC = 00:00:00:00] to [TC = 00:00:00:12] of the Bridge Essence specified by the codes in the eighth and the ninth lines are decoded with the decoder 155₁.

[decoder = “1”] in the thirteenth line specifies that the pictures from [TC = 00:00:00:17] to [TC = 00:00:00:27] of the Bridge Essence specified by the codes in the eleventh and the twelfth lines are decoded with the decoder 155₂.

[decoder = “0”] in the sixteenth line specifies that the pictures from [TC = 00:00:01:03] to [TC = 00:00:01:14] of the Bridge Essence specified by the codes in the fourteenth and the fifteenth lines are decoded with the decoder 155₁.

[decoder = “0”] in the nineteenth line specifies that pictures on and after [TC = 00:10:00:15] of the Clip #3 specified by the codes in the eighteenth and the nineteenth lines are decoded with the decoder 155₁.

As described above, the decoder specifying information (the description) is provided for the reproducing apparatus 101 of FIG. 24, after being added to the Play List.

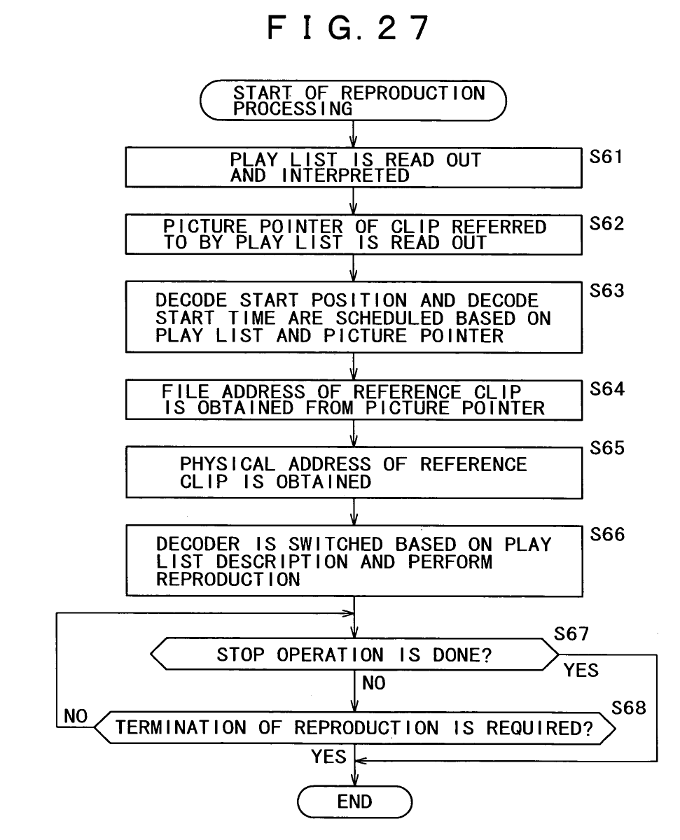

A reproduction processing performed with the reproducing apparatus 101 of FIG. 24 according to the Play List containing the decoder specifying information is now described with reference to a flowchart of FIG. 27.

The processing of FIG. 27 is basically similar to the processing of FIG. 20, except that the decoder selection processing (the processing corresponding to Step S34 of FIG. 20) is eliminated from the former processing. Specifically, in Step S66, the decoder control unit 124 switches the decoder based on the description of the Play List to reproduce (decode) the image data. Other steps of the processing of FIG. 27 are similar to the above, and therefore, a detailed description thereof is omitted.

Incidentally, when the optical disk 52 containing the Play List of FIG. 26 is placed, the image data recorded on the optical disk 52 together with the Play List is decoded with the reproducing apparatus 101 after the decoder is switched as shown in FIG. 21.

As described above, when the decoder specifying information is contained in the Play List, the decoder selection preprocessing having been performed in the processing of FIG. 20 is not required for the reproducing apparatus 101 of FIG. 24. Thus, it is allowable to start the reproduction of the image data more quickly.

Further, it is also allowable to ensure the real-time efficiency of the reproduction performed with the reproducing apparatus 101.

Furthermore, the switching of the decoder in consideration of the video image continuity is attainable, leading to upgrading of the image quality.

While the above embodiments are arranged to apply the description in the Play List, that is, [decoder = “0”], [decoder = “1”], to specify the decoder, it may be also modified, in the case of the reproducing apparatus 101 having a large number of decoders (three ore more decoders), to specify the decoder in two or more bits, like [decoder = “00”], [decoder = “01”],

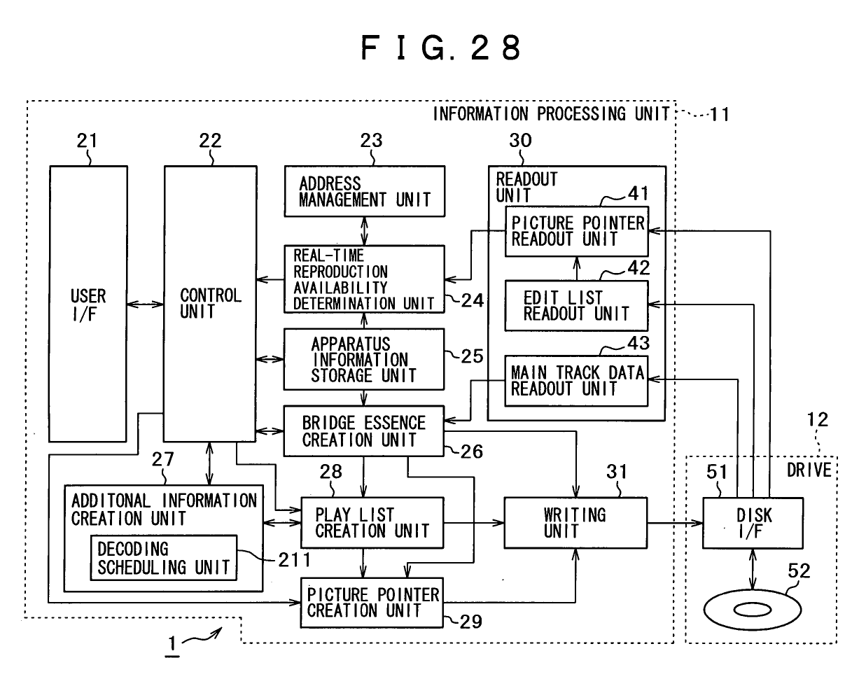

FIG. 28 is a block diagram showing a further different embodiment of the configuration of the disk apparatus 1. In FIG. 28, the same units as those in FIG. 2 are designated by the like reference numerals, and a description thereof is omitted appropriately.

The disk apparatus 1 of FIG. 28 has the additional information creation unit 27 having a decode scheduling unit 211, unlike the disk apparatus 1 of FIG. 2.

The decode scheduling unit 211 creates the schedule information representing the decode start position etc. as the additional information to supply the schedule information to the Play List creation unit 28. Specifically, while the reproducing apparatus 101 of FIG. 6 is arranged to perform the decode scheduling and the decoder selection (Steps S33 and S34 of FIG. 20) as the preprocessing at the time of reproduction of the image data, this embodiment is modified such that the scheduling is performed in advance with the disk apparatus 1, and the schedule information is contained in the Play List.

Accordingly, the reproducing apparatus 101 enables the reproduction processing to start quickly without performing the decode scheduling as the preprocessing at the time of reproduction of the image data. Further, the above reproduction processing results in attainment of reproduction whose real-time efficiency is ensured.

The decode scheduling unit 211 also creates the schedule information representing the decode end position to supply the schedule information to the Play List creation unit 28. As described above, in the case of encoding with Long GOP, the presence of the non-displayed picture to be decoded before a certain picture is decoded sometimes leads to misalignment between the display end position and the decode end position depending on the position of the OUT point (depending on the type of the picture at the OUT point), just as misalignment arises between the display start position and the decode start position. Thus, the decode scheduling unit 211 performs the scheduling so as to describe the information representing the decode end position also in the Play List, and supplies the created schedule information to the Play List creation unit 28.

The decode scheduling unit 211 performs the decode scheduling based on the information supplied from the control unit 22, such as the Edit List, the Bridge Essence-related information, the picture pointer and the device information etc. on the reproducing apparatus 101 such as the number of decoders.

As described above with reference to FIGS. 8 and 9 etc., the decode scheduling unit 211 detects the picture at the edit point from the Edit List supplied from the control unit 22 to acquire the type of the picture at the edit point from the picture pointer. The decode scheduling unit 211 also detects, depending on the picture at the edit point (IN point), the number of pictures to be decoded before the picture at the edit point is decoded, and then determines the decode start position and the decode start time.

The determined schedule information specified as the scheduling result is outputted from the decode scheduling unit 211 to the Play List creation unit 28.

The Play List creation unit 28 adds, based on the schedule information, the information specifying the decode start position (the decoder switch position) to the Play List in terms of attribute information (Attribute) by the name of [decBegin], for instance. The Play List creation unit 28 also adds the information representing the number of I, P pictures to be decoded before the picture at the edit point is decoded, to the Play List in terms of attribute information by the name of [preDecDur], for instance, as required.

The Play List creation unit 28 further adds, based on the schedule information, the information specifying the decode end position to the Play List in terms of attribute information by the name of [decEnd], for instance. The Play List creation unit 28 further adds the information representing the number of pictures to be decoded for decoding the picture at the OUT point, that is, pictures posterior in display sequence to the picture at the OUT point, to the Play List in terms of attribute information by the name of [postDecDur], for instance, as required.

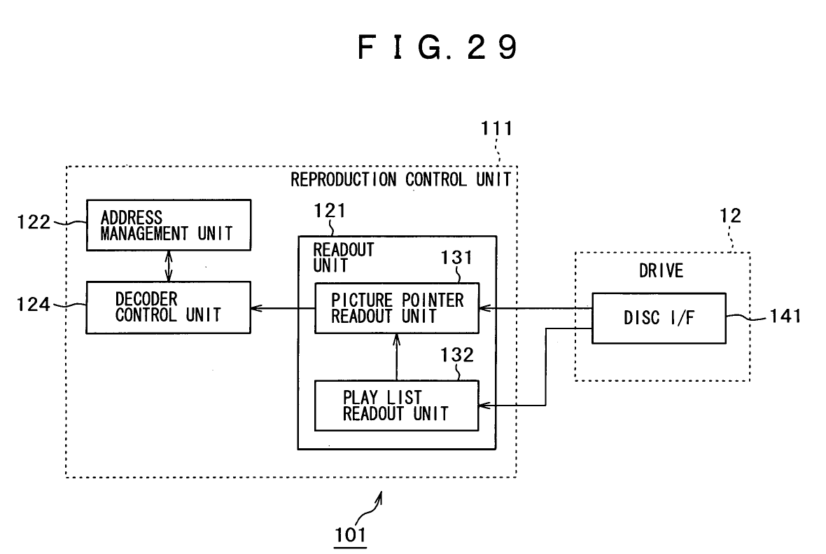

FIG. 29 is a block diagram showing a further different embodiment of the configuration of the reproducing apparatus 101.

The reproducing apparatus of FIG. 29 is to reproduce the image data according to the Play List created with the disk apparatus 1 of FIG. 28.

The Play List created with the disk apparatus 1 of FIG. 28 contains the attribute information that specifies the decode start position and the decode end position, so that the reproducing apparatus 101 does not need to perform the decode scheduling as the preprocessing at the time of reproduction of the image data. Thus, the reproducing apparatus 101 of FIG. 29 has neither the decode scheduling unit 123 nor the decoder selection part 133 incorporated in the decode scheduling unit 123, unlike the reproducing apparatus 101 of FIG. 6.

Other configurations of the reproducing apparatus 101 of FIG. 29 are similar to those of the reproducing apparatus 101 of FIG. 6. Specifically, the decode processing is controlled with the decoder control unit 124 based on the Play List and the picture pointer supplied from the picture pointer readout unit 131 to decode the image data. When a value of preDecDur Attribute is equal to or more than 1, in other words, in the presence of the picture to be pre-decoded although not displayed, for instance, the decoder control unit 124 switches the decoder so as to be decoded with the decoder that is not available for decoding at that time. A description on the other configurations similar to those in FIG. 6 is omitted.

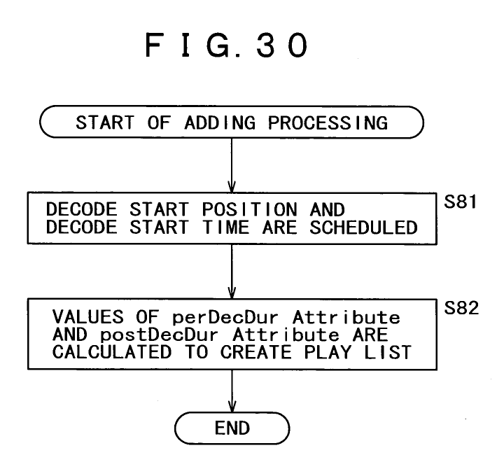

An attribute information adding processing performed with the disk apparatus 1 of FIG. 28 is next described with reference to a flowchart of FIG. 30.

Like the processing of FIG. 25, the processing of FIG. 30 is also started when it is determined in Step S11 of FIG. 13 that the additional information is required for creation of the Play List.

When a request of the additional information is issued from the Play List creation unit 28, the decode scheduling unit 211 schedules, in Step S81, the decode start position and the decode end position for decoding with each decoder. Specifically, the scheduling as described above with reference to FIGS. 8 and 9 etc. is performed herein to determine the decode start position.

When it is determined based on the type of the picture at the OUT point that there are other pictures to be decoded before the picture at the OUT point is decoded although not displayed, the decode scheduling unit 211 specifies, as the decode end position, a position posterior to the OUT point position by an interval corresponding to the number of the above other pictures.

Specifically, when the picture at the OUT point is of the B picture type, it is necessary to decode one I or P picture, which is posterior in display sequence to the B picture and is therefore not displayed, for decoding the B picture, in which case the position posterior in display sequence to the OUT point position by an interval corresponding to the above one picture is specified as the decode end position. Conversely, when the picture at the OUT point is of the I or P picture type, the OUT point position is equal to the decode end position, because of the absence of the non-displayed picture to be pre-decoded for decoding the I or P picture.

With this consideration, a value of postDecDur Attribute specified as the information contained in the Play List to represent the number of pictures to be decoded for decoding other pictures is assumed to be [1] when the picture at the OUT point is of the B picture type, while being assumed to be [0] when the picture at the OUT point is of the I or P picture type.

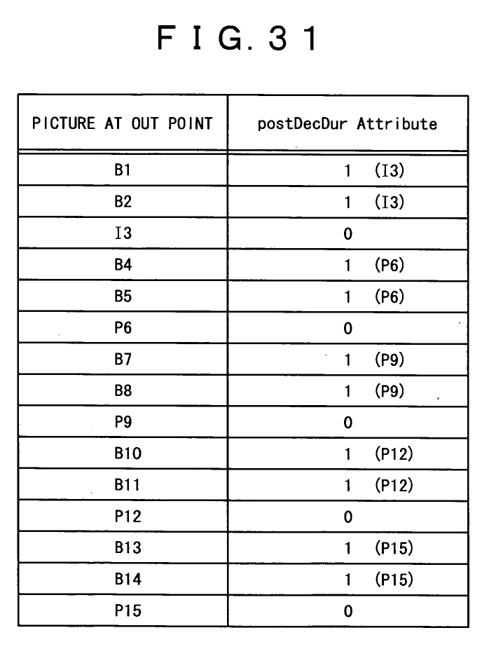

FIG. 31 illustrates a correspondence between the pictures at the OUT point and value of postDecDur Attribute.

As shown in FIG. 31, when the picture at the OUT point is the B1 or B2, it is necessary to decode the non-displayed picture I3 (the picture shown in [( )] in the Figure) before the picture B1 or B2 is decoded, so that the value of postDecDur Attribute is assumed to be [1].

When the picture at the OUT point is the 13, the value of postDecDur Attribute is assumed to be [0], because of the absence of the non-displayed picture to be decoded before the picture I3 is decoded.

When the picture at the OUT point is the B4 or B5, it is necessary to decode the non-displayed P6 before the picture B4 or B5 is decoded, so that the value of postDecDur Attribute is assumed to be [1].

When the picture at the OUT point is the P6, the value of postDecDur Attribute is assumed to be [0], because of the absence of the non-displayed picture to be decoded before the picture P6 is decoded.

When the picture at the OUT point is the B7 or B8, it is necessary to decode the non-displayed picture P9 before the picture B7 or B8 is decoded, so that the value of postDecDur Attribute is assumed to be [1].

When the picture at the OUT point is the P9, the value of postDec Dur Attribute is assumed to be [0], because of the absence of the non-displayed picture to be decoded before the picture P9 is decoded.

When the picture at the OUT point is the B10 or B11, it is necessary to decode the non-displayed picture P12 before the picture B10 or B11 is decoded, so that the value of post DecDur Attribute is assumed to be [1].

When the picture at the OUT point is the P12, the value of postDecDur Attribute is assumed to be [0], because of the absence of the non-displayed picture to be decoded before the picture P12 is decoded.

When the picture at the OUT point is the B13 or B14, it is necessary to decode the non-displayed P15 before the picture B13 or B15 is decoded, so that the value of postDecDur Attribute is assumed to be [1].

When the picture at the OUT point is the P15, the value of postDecCur Attribute is assumed to be [0], because of the absence of the non-displayed picture to be decoded before the picture P15 is decoded.

In Step S82, the Play List creation unit 28 adds, based on the schedule information supplied from the decode scheduling unit 211, decBegin Attribute specified as the attribute information representing the decode start position and decEnd Attribute specified as the attribute information representing the decode end position to the Play List created in Step S10 of FIG. 13 to create the Play List containing the additional information.

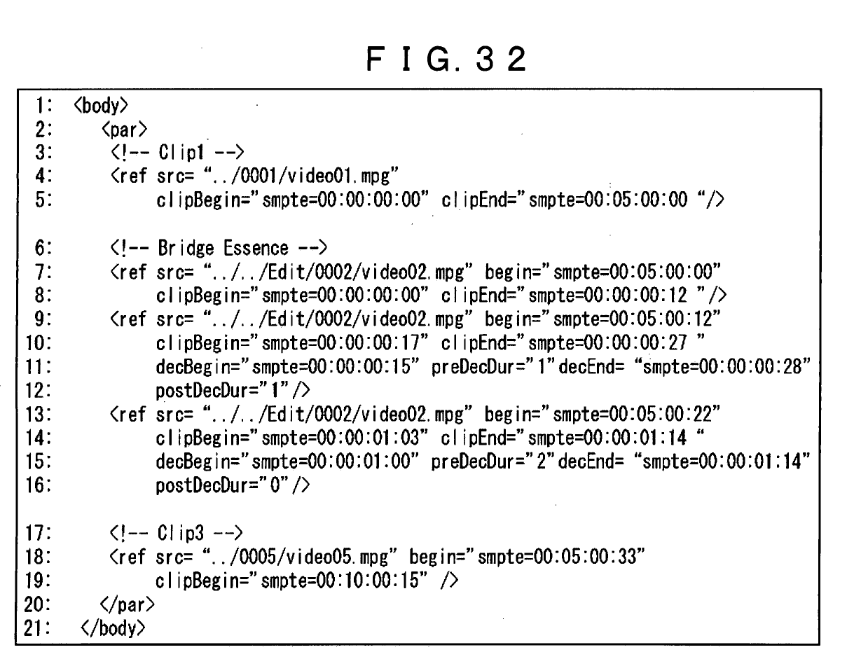

FIG. 32 illustrates an embodiment of the Play List additionally containing the attribute information representing the decode start position and the attribute information representing the decode end position. The Play List shown in FIG. 32 contains not only preDecDur Attribute specified as the attribute information representing the number of I or P pictures to be decoded before the picture at the edit point is decoded but also postDecDur Attribute. The value of preDecDur Attribute (the number of pictures) is calculated through the processing of FIG. 8, while the value of postDecDur Attribute is calculated through the processing of FIG. 31.

The Play List of FIG. 32 is similar to the Play List of FIG. 26, except that the former Play List contains decBegin Attribute, preDecDur Attribute, decEnd Attribute and postDecDur Attribute respectively added to the eleventh, the twelfth, the fifteenth and the sixteenth lines, and contains no decoder specifying information.

Specifically, [decBegin = “smpte = 00:00:00:15”] in the eleventh line indicates that the Bridge Essence specified by the codes in the ninth and the tenth lines is decoded so as to be started with [TC = 00:00:00:15]. Further, [preDecDur = “1”] indicates that the number of I, P pictures to be pre-decoded for decoding the picture to be displayed at [TC = 00:00:00:17] is [1].

The reproducing apparatus 101 may reproduce, in real time, the pictures of the Bridge Essence to be displayed when [TC = 00:00:00:17] is reached, by starting decoding with [TC = 00:00:00:15] based on the attribute information.

Incidentally, the decoder different from the decoder having been used up to now to decode the Bridge Essence specified by the codes in the seventh and the eight lines is applied to start decoding with [TC = 00:00:00:15] specified by decBegin Attribute. As described above, when the value of preDecDur Attribute is equal to or more than 1, the decoder is switched.

[decEnd = “smpte = 00:00:00:28”] in the eleventh line indicates that the Bridge Essence specified by the codes in the ninth and the tenth lines is decoded up to [TC = 00:00:00:28]. Specifically, in this embodiment, the picture at the OUT point is considered to be of the B picture type, in which case the misalignment arises between the position of the picture at the OUT point (clipEnd = “smpte = 00:00:00:27”) and the decode end position (decEnd = “smpte = 00:00:00:28”).

[postDecDur = “1”] in the twelfth line indicates the presence of one non-displayed picture to be decoded before the picture at the OUT point is decoded.

Likewise, [decBegin = “00:00:01:00”] in the fifteenth line indicates that the Bridge Essence specified by the codes in the thirteenth and the fourteenth lines is decoded so as to be started with [TC = 00:00:01:00]. Further, [preDecDur = “2”] indicates that the number of I, P pictures to be pre-decoded for decoding the picture to be displayed at [TC = 00:00:01:03] is [2].

The reproducing apparatus 101 may reproduce, in real time, the pictures of the Bridge Essence to be displayed when [TC = 00:00:01:00] is reached, by starting decoding with [TC = 00:00:01:00] based on the attribute information.

Incidentally, the decoder different from the decoder having been used up to now to decode the Bridge Essence specified by the codes in the ninth and the tenth lines is applied to start decoding with [TC = 00:00:01:00] specified by the decBegin Attribute.

[decEnd = “smpte = 00:00:01:14”] in the fifteenth line indicates that the Bridge Essence specified by the codes in the thirteenth and the fourteenth lines is decoded up to [TC = 00:00:01:14]. Specifically, in this embodiment, the picture at the OUT point is considered to be of the I or P picture type, in which case the position of the picture at the OUT point (clipEnd = “smpte = 00:00:01:14”) is equal to the decode end position (decEnd = “smpte = 00:00:01:14”).

[postDecDur = “0”] in the sixteenth line represents the absence of the non-displayed picture to be decoded before the picture at the OUT point is decoded.

As described above, the information that specifies the decode start position and the decode end position is provided for the reproducing apparatus 101 of FIG. 29 after being added to the Play List in advance with the disk apparatus 1.

As shown also in FIG. 32, a positional relation between clipBegin and decBegin and that between clipEnd and decEnd are expressed as follows.
DecBegin =< clipBegin
ClipEnd =< decEnd

Further, when the image data position is specified by the time codes as shown in FIG. 32, preDecDur and postDecDur are respectively expressed as follows.
PreDecDur =< clipBegin-decBegin
PostDecDur =< decEnd-clipEnd
wherein these expressions are given in units of frame numbers.

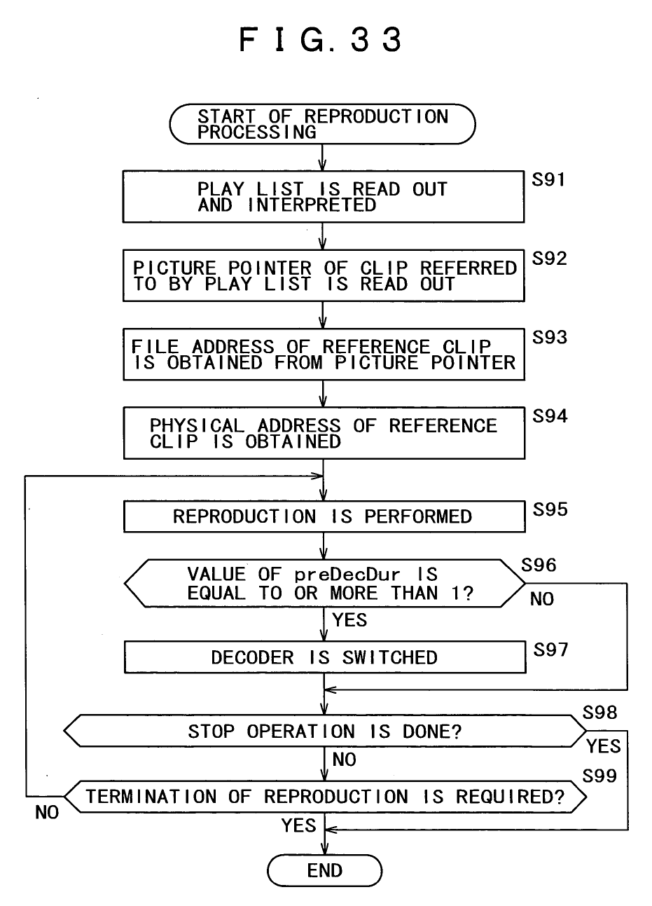

A reproduction processing performed with the reproducing apparatus 101 of FIG. 29 according to the Play List additionally containing the attribute information that specifies the decode start position and the decode end position is now described with reference to a flowchart of FIG. 33.

The processing of FIG. 33 is different from the processing of FIG. 20 or 27 in that the decode scheduling (the processing corresponding to Step S33 of FIG. 20 and Step S63 of FIG. 27) is eliminated from the former processing.

In the processing of FIG. 33, after the start of reproduction (decode) in Step S95, it is determined in Step S96 by the decoder control unit 124 whether or not the value of preDecDur Attribute of the code in the Play List now available for the reference is equal to or more than 1.

In Step S96, when it is determined that the value of preDecDur Attribute is not equal to or more than 1, the processing moves on to Step S98, wherein the processing similar to the processing as described above with reference to FIG. 20 follows.

Conversely, in Step S96, when it is determined that the value of preDecDur Attribute is equal to or more than 1, the processing moves on to Step S97, wherein the decoder control unit 124 starts decoding with the decoder different from the decoder having been used up to now to decode. Other steps in the processing of FIG. 33 are similar to the above, and a description thereof is omitted.

As described above, when the information representing the decode start position and the decode end position is contained in the Play List, the decode scheduling is not required for the reproducing apparatus 101 as the preprocessing of the reproduction of the image data. Further, the decoder is switched at the time when the value of preDecDur Attribute value is equal to or more than 1 (there is the need for pre-decoding), so that the decoder selection processing is not required too.

With the above processing, in the reproducing apparatus 101 of FIG. 29 having the Play List of FIG. 29, for instance, the decode processing as described above with reference to FIG. 21 is performed with the decoders 155₁ and 155₂.

Specifically, the decode start position (the position to be started pre-decoding for decoding the picture at the IN₂ point) in the range A₁ of FIG. 21 is at [TC = 00:00:00:15] specified by decBegin Attribute in the eleventh line of FIG. 32. Further, the decode start position (the position to be started pre-decoding for decoding the picture at the IN₃ point) in the range A₂ of FIG. 21 is at [TC = 00:00:01:00] specified by decBegin Attribute in the fifteenth line of FIG. 32.

Incidentally, as shown in FIG. 21, after switching of the decoder, the decoder 155₂ different from the decoder 155₁ having been used up to now (up to the OUT₂ point) to decode is applied to start decoding with [TC = 00:00:00:15] specified by decBegin Attribute in the eleventh line of FIG. 32. Further, after switching of the decoder, the decoder 155₁ different from the decoder 155₂ having been used up to now (up to the OUT₂ point) to decode is applied to start decoding with [TC = 00:00:01:00] specified by decBegin Attribute in the fifteenth line of FIG. 32.

As described above, the reproducing apparatus 101 may start the reproduction processing quickly without performing the decode scheduling and the decoder selection as the preprocessing at the time of reproduction of the image data. Further, the above reproduction processing results in reproduction whose real-time efficiency is ensured.

Further, the reproducing apparatus 101 merely needs to switch the decoder according to the description of the Play List, so that in the case of variations in the hardware arrangement such as an increase in the number of decoders after the creation of the Play List with the disk apparatus 1, it is allowable to meet the above variations.

In the case of the increase in the number of decoders of the reproducing apparatus 101 after the creation of the Play List in which the decoder is directly specified with the disk apparatus 1, as shown in FIG. 26, for instance, the reproducing apparatus 101 fails to establish the correspondence between the decoder specified by the Play List and the decoder of the reproducing apparatus 101, leading to a failure in the reproduction of the image data according to the Play List.

Further, even in the case of the reproduction performed with an apparatus (the reproducing apparatus) having the decoders that are not equal in number to the decoders presumed at the time of creation of the Play List, the above reproducing apparatus is allowed to perform the reproduction of the image data based on the Play List.

Thus, the disk apparatus 1 may be supposed to create the Play List generally used for apparatuses of various arrangements.

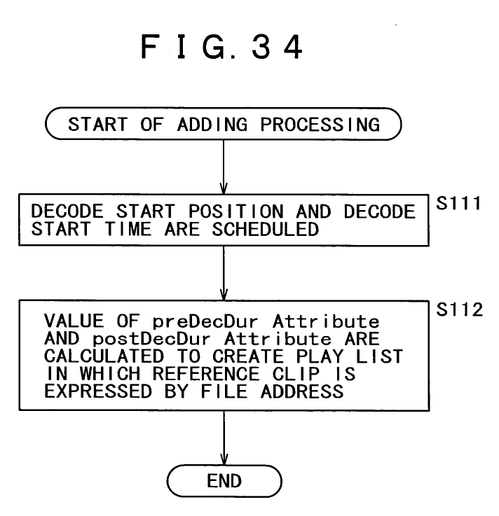

A different adding processing performed with the disk apparatus 1 of FIG. 28 is now described with reference to a flowchart of FIG. 34.

The processing of FIG. 34 is different from the processing of FIG. 30 in that the former processing is effective in creating a Play List that not only contains the attribute information such as decBegin Attribute and decEnd Attribute respectively specifying the decode start position and the decoded end position, but also allows the reference Clip to be specified in Step S112 by the file address adaptable to be processed with the reproducing apparatus 101. The processing in Step S111 is similar to the processing in Step S81 of FIG. 30.

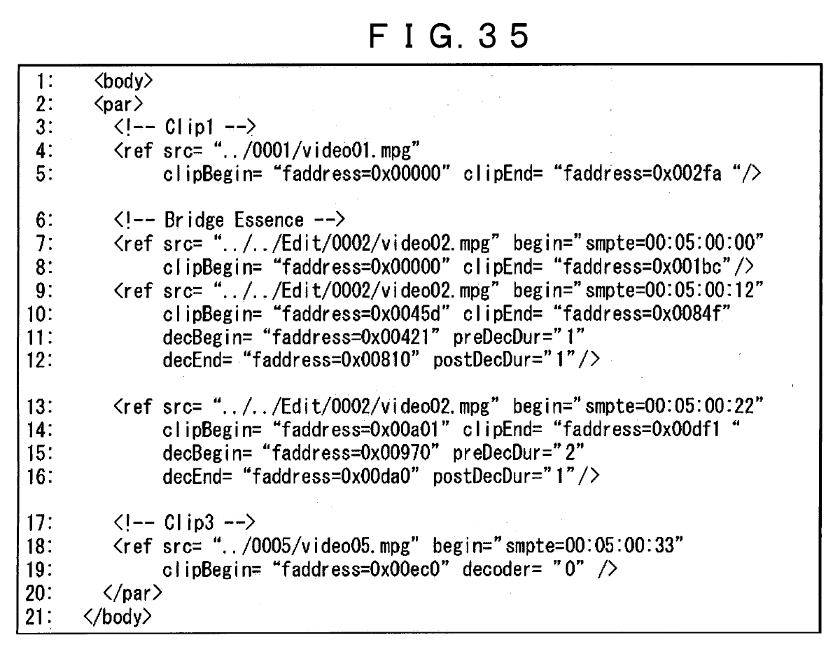

FIG. 35 illustrates an embodiment of the Play List created through the processing of FIG. 34. The Play List of FIG. 35 is basically similar to the Play List of FIG. 32.

The reference Clip is specified by a file address (the logical address), like [clipBegin = “faddress = 0x00000” clipEnd = “faddress = 0x002fa”], in the fifth line of the Play List of FIG. 35, instead of the time code like the Play List of FIG. 32.

The above file address is that obtained, with the Play List creation unit 28 of FIG. 28, from the picture pointer supplied from the control unit 22.

Likewise, the reference Clips are specified by [clipBegin = “faddress = 0x00000” clipEnd = “faddress = 0x001bc”] in the eighth line, by [clipBegin = “faddress = 0x0045d” clipEnd = “faddress = 0x0084f”] in a tenth line, by [decBegin = “faddress =0x00421”] in the eleventh line, by [clipBegin = “faddress = 0x00a01” clipEnd = “faddress = 0x00df1”] in the fourteenth line, by decBegin = “faddress = 0x00970”] in the fifteenth line, and by [clipBegin = “faddress = 0x00ec0”] in the nineteenth line, respectively.

Further, the decode end positions are also specified by [decEnd = “faddress = 0x00810”] in the twelfth line, and by [decEnd = “faddress = 0x00da0”] in the sixteenth line, respectively. Herein, in FIG. 35, the position (faddress = 0x00da0, for instance) specified by decEnd is placed anterior to the position (faddress = 0x00df1, for instance) specified by clip End, unlike the processing in the case of FIG. 32. This is because in the case of specifying the file address by the position, the file address is assigned to each picture in the image data decode sequence.

As described above, the reproducing apparatus 101 of FIG. 29 having the Play List may eliminate the preprocessing at the time of reproduction, i.e., the processing of acquiring the file address of the reference Clip from the picture pointer in such a manner as to specify the reference range by the file address in advance. Specifically, in this case, the reproducing apparatus 101 of FIG. 29 may also start the reproduction processing more quickly.

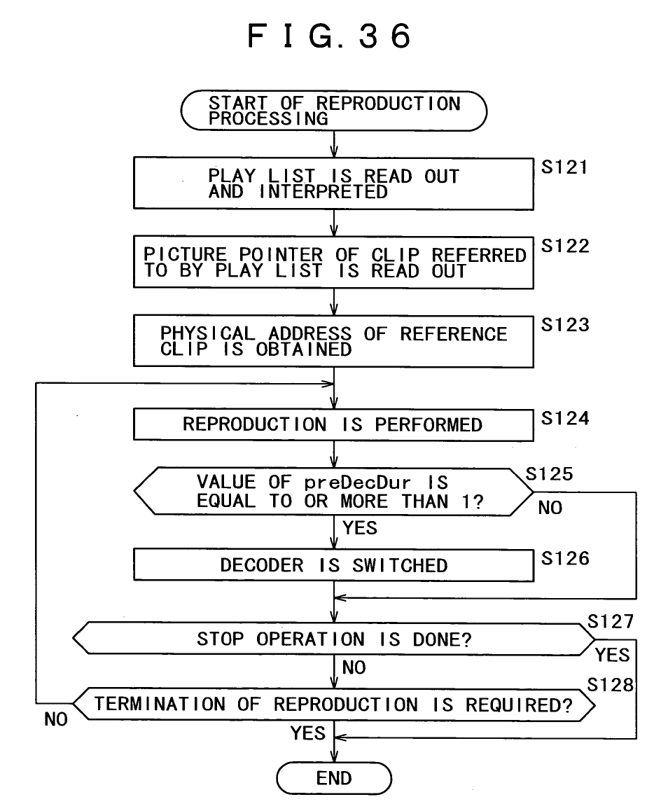

A reproduction processing performed with the reproducing apparatus 101 of FIG. 29 having the Play List of FIG. 35 is now described with reference to a flowchart of FIG. 36.

The processing of FIG. 36 is different from the processing of FIG. 33 in that the processing (the processing corresponding to Step S93 of FIG. 33) of acquiring the file address of the reference Clip form the picture pointer is eliminated from the former processing. Specifically, the decoder control unit 124 of FIG. 29 acquires, in Step S123, the physical address of the reference Clip from the address management unit 122 based on the file address described in the Play List.

The decoder control unit 124 having the physical address of the reference Clip performs the following image data reproduction processing similar to that as described above with reference to FIG. 33.

Thus, the reproducing apparatus 101 of FIG. 29 may start the reproduction of the image data more quickly without performing the preprocessing such as the decode scheduling, the decoder selection and the file address acquisition. Further, the above reproduction processing results in reproduction whose real-time efficiency is ensured.

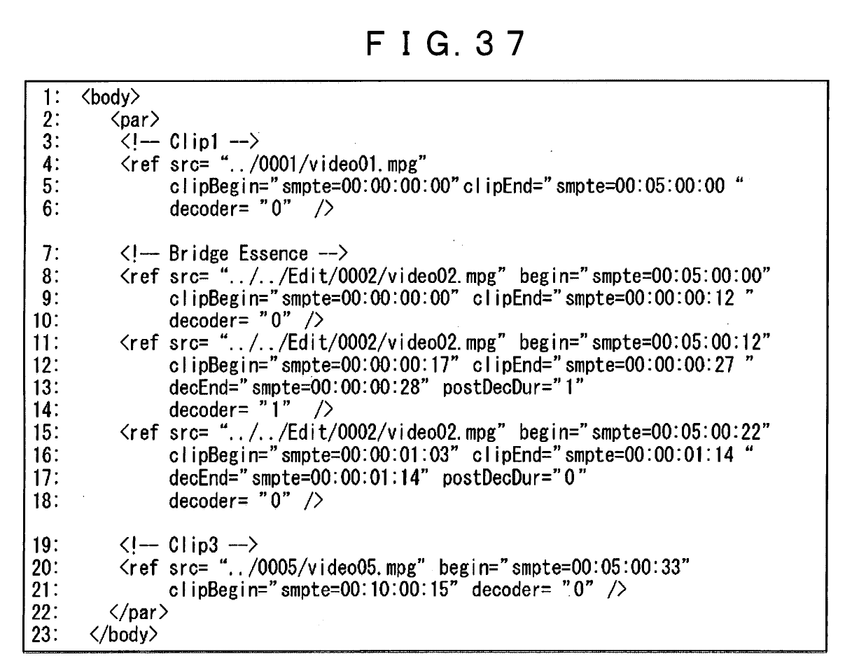

As described above, various kinds of attribute information such as the decoder specifying information, the decode start position or the decode end position may be added to the Play List. As a matter of course, it may be modified that the decoder specifying information (decoder = “0”, “1”) is described in combination with the information (decEnd) representing the decode end position etc. in the Play List as the additional information, as shown in FIG. 37.

While the above embodiments are arranged that both of decEnd Attribute and postDecDur Attribute are described in the Play List, the reproducing apparatus having the Play List describing only decEnd Attribute may also judge the value of postDecDur Attribute (1 or 0) by itself.

When a value of [clipend] is different from a value of [decEnd] as described in the tenth and the eleventh lines of FIG. 32, for instance, the reproducing apparatus 101 may judge the value of postDecDur Attribute to be [1]. Conversely, when the value of [clipend] and the value of [decEnd] are the same as described in the fourteenth and the fifteenth lines, the reproducing apparatus 101 may judge the value of postDecDur Attribute to be [0].

Further, as described above with reference to FIG. 31, when the picture at the OUT point is of the B picture type, the value of post decDur Attribute is assumed to be [1], in which case it may be arranged to acquire the type of the picture at the OUT point from the picture pointer so as to judge the value of postDecDur Attribute based on the acquired picture type.

Further, it may be also modified that only postDecDur Attribute is described in the Play List, without any description of the value of decEnd attribute. With this modification, the reproducing apparatus 101 having the the Play List may also judge, from the value of postDecDur Attribute, whether or not the misalignment between the OUT point position and the decode end position arises, thereby enabling the decoder control etc. based on the result of judgement. Specifically, decEnd and postDecDur Attribute etc. are considered to be redundant information, so that it is allowable to eliminate these kinds of information when the reproducing apparatus 101 is arranged to be capable of judgement of the above values with reference to other information.

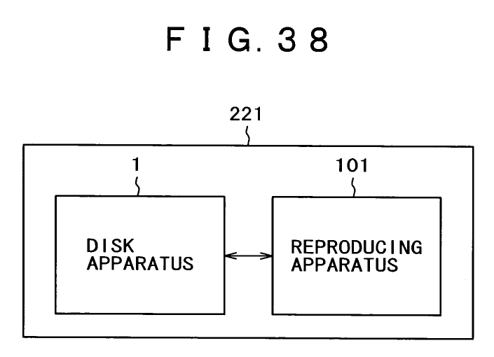

While the disk apparatus land the reproducing apparatus 101 are configured as individually different apparatuses in the above embodiments, it may be also modified that these apparatuses are united into an information processing apparatus 221, as shown in FIG. 38.

In this case, the Play List created with the disk apparatus 1 is outputted to the reproducing apparatus 101 to permit the reproducing apparatus 101 to perform the real-time reproduction of the image data according to the Play List supplied from the disk apparatus 1.

While the above embodiments are arranged to provide the Play List created with the disk apparatus 1 for the reproducing apparatus 101 after being recorded on the optical disk 52, it may be also modified that the Play List is provided over a network together with the image data and the picture pointer etc. Further, it may be also modified that the information such as the Play List is provided for the reproducing apparatus 101 through the removable media 70 (FIG. 5) such as the memory card integrated with the flash memory, the removable hard disk and the optical card.

While the above embodiments have been mainly described on the case where the reproducing apparatus 101 has two decoders, it may be also modified that the reproducing apparatus has the one decoder or three or more decoders.

While in the above embodiments, the one GOP composed of the pictures B1, B2, I3, B4, B5, P6, B7, B8, P9, B10, B11, P12, B13, B14 and P15 is employed, the present invention is of course also applicable to any different-structured GOP.

The present invention is also applicable to a case of a processing of the image data with predictive coding other than MPEG2.

While in the above embodiments, the image data recorded on the optical disk 52 is specified as the object of reproduction, the present invention is also applicable to a case of the reproduction of image data recorded on a magnetic disk, a magnetic tape, a semiconductor memory and other recording mediums than the optical disk 52 or image data transmitted through a transmission medium such as Internet.

The above series of processing is executable with the hardware, or alternatively, with software. In the case of the execution of the above series of processing with the software, a program contained in the software is installed in a general-purpose computer etc.

When the execution of the above series of processing with the software is required, a program contained in the software is installed, through the network or the recording medium, to a computer incorporated in a dedicated hardware or a general-purpose computer, for instance, capable of the execution of various functions by installation of various kinds of programs.

The recording medium includes not only one configured with a package medium distributed so as to provide the program for the user, such as the optical disk 52 or the removal media 70 containing the program, but also one configuration with a hard disk provided for the user in a condition where it is pre-integrated in the apparatus body, such as the hard disk incorporated in the ROM 62 or the storage unit 68 containing the program.

It is understood that in the present specification, Steps for the description of the program recorded on the recording medium are those including not only a time series processing performed according to the sequence listed but also a processing performed concurrently or individually although being not always necessary to be performed in time series.

Further, the program may be one processed with one computer, or alternatively, distributive-processed with a plurality of computers. Furthermore, the program maybe also one transferred to a remote computer into execution.

1. An information creating apparatus for creating reproduction control information proposed to a reproducing apparatus to reproduce a predetermined data, comprising:
acquisition means of acquiring edit point information describing a start point and an end point that are set to said data; and
creation means of creating said reproduction control information that controls reproduction of the data based on the edit point information, wherein;
said reproduction control information includes either information representing the number of second pictures at the post-end point or information representing a decode end position required to display from the start point to the end point, where both of the information are decoded before a first picture at the end point is decoded.

2. The information creating apparatus as cited in claim 1, wherein;
said creation means is arranged to perform creation of said reproduction control information which further includes either information representing the number of fourth pictures at the post-start point or information representing a decode start position required to start displaying with the start point, where both of the information are decoded before a third picture at the start point is decoded.

3. The information creating apparatus as cited in claim 1, wherein;
said creation means is arranged to perform creation of reproduction control information which further includes information specifying a decoder of a reproducing apparatus to be used to decode the data.

4. The information creating apparatus as cited in claim 1, wherein;
said creation means is arranged to perform creation of reproduction control information that specifies a data position by address information adaptable to be processed with the reproducing apparatus.

5. An information creating method for creating information proposed to a reproducing apparatus to reproduce a predetermined data, comprising:
an acquisition step of acquiring edit point information describing a start point and an end point that are set at data; and
a creation step of creating reproduction control information that controls reproduction of the data based on the edit point information, wherein;
said reproduction control information includes either information representing the number of second pictures at the post-end point or information representing a decode end position required to display from the start point to the end point, where both of the information are decoded before a first picture at the end point is decoded.

6. A program comprising:
an acquisition step of acquiring edit point information describing a start point and an end point that are set at data; and
a creation step of creating reproduction control information that controls reproduction of the data based on the edit point information, wherein;
said reproduction control information includes either information representing the number of second pictures at the post-end point or information representing a decode end position required to display from the start point to the end point, where both of the information are decoded before a first picture at the end point is decoded.

7. A reproducing apparatus comprising:
acquisition means of acquiring a reproduction control information created based on edit point information describing a start point and an end point that are set at prescribed data; and
reproduction means of reproducing the data based on the reproduction control means acquired with the acquisition means, wherein;
said reproduction control information includes either information representing the number of second pictures at the post-end point or information representing a decode end position required to display from the start point to the end point, where both of the information are decoded before a first picture at the end point is decoded.

8. A reproducing method comprising:
an acquisition step of acquiring reproduction control information created based on edit point information describing a start point and an end point that are set at prescribed data; and
a reproduction step of reproducing the data based on the reproduction control information acquired through a processing in the acquisition step, wherein;
said reproduction control information includes either information representing the number of second pictures at the post-end point or information representing a decode end position required to display from the start point to the end point, where both of the information are decoded before a first picture at the end point is decoded.

9. A computer-readable program comprising:
an acquisition step of acquiring reproduction control information created based on edit point information describing a start point and an end point that are set at prescribed data; and
a reproduction step of reproducing the data based on the reproduction control information acquired through a processing in the acquisition step, wherein;
said reproduction control information includes either information representing the number of second pictures at the post-end point or information representing a decode end position required to display from the start point to the end point, where both of the information are decoded before a first picture at the end point is decoded.
